(19) United States
(12) Patent Application Publication
(10) Pub. No.: US 2016/0125127 A1
(43) Pub. Date: May 5, 2016

(54) IDENTIFICATION OF MINIMAL COMBINATIONS OF ONCOPROTEINS IN NOTCH PATHWAY TO SUPPRESS HUMAN GLIOBLASTOMA

(71) Applicant: Council of Scientific & Industrial Research, New Delhi (IN)

(72) Inventors: Ram Rup SARKAR, Pune (IN); Saikat CHOWDHURY, Pune (IN)

(21) Appl. No.: 14/527,628

(22) Filed: Oct. 29, 2014

(51) Int. Cl. G06F 19/18; C40B 30/02

(52) U.S. Cl. CPC G06F 19/18; C40B 30/02

(57) ABSTRACT

The invention is directed to in-silico method to identify combinatorial oncoprotiens as potential drug targets or combinatorial oncoprotien biomarkers in NOTCH pathway to suppress the human Glioblastoma proliferation.

### FIELD OF INVENTION

The invention is directed to in-silico method to identify combinatorial oncoproteins as potential drug targets or combinatorial oncoprotein biomarkers in NOTCH pathway to suppress the human Glioblastoma proliferation.

### BACKGROUND OF THE INVENTION

In the current era in oncology, much hope for powerful new therapies lies with targeted inhibition of pathways dysregulated in cancer. Gliomas are among the most lethal tumors seen in adults and currently there is no effective cure. The tumors are derived from brain glial tissue and comprise several diverse tumor forms and grades. Recently, a population of cells, capable of clonal growth in-vitro and tumor formation in-vivo, has been identified in gliomas. These cells are defined as brain cancer stem cells (bCSC) and share profound similarity to normal neural stem cells (NSC).

Notch signalling pathway is widely implicated in controlling various cellular functions, cell fate determination, and stem cell renewal in human but aberrant activity in cancer stem cells may cause different types of cancers including glioblastoma. Notch promotes cell survival, angiogenesis and treatment resistance in numerous cancers, making it a promising target for cancer therapy. Notch is found to play an important oncogenic role in cell types that it favors in development and differentiation, such as glial cells or T-cells. It also crosstalks with Hedgehog and Wnt pathways, and provides a means to affect numerous signalling pathways with one intervention.

In the cancer scenario, most of the cancer cell lines show significant level of up regulation of its activator proteins (Onco-proteins) and down regulations of its tumor suppressor proteins. The “gain or loss” of functions of these Notch pathway associated proteins have proved its correlation with cancer development, and hence can be used as a biomarker for cancer diagnosis. Various molecular biology experiments have also shown that inhibition of the activators of this pathway can drastically reduce the cancer progression in different stages. Consequently, identification of drug targetable proteins and their small molecule inhibitors in the pathway to reduce cancer development has always been an important field of research to the pharmacists and clinical biologists.

Presently, GAMMA SECRETASE is found to reduce the Notch pathway activity by not allowing it to cleave the Notch receptor in the membrane and is a probable drug target in the NOTCH pathway. However, the compound Semagacestat (LY450139), which inhibits the GAMMA SECRETASE failed to meet the desired goal as it was compromising with several risk factors including skin cancer.

In addition to GAMMA SECRETASE, various other probable drug target molecules in NOTCH pathway are identified in literatures such as NOTCH1, NOTCH4, DLL4, NRARP, APP (amyloid precursor protein), CD44, ErbB4, LRP, syndecan-3, p75 NTR, Apo ER2, DCC, Nectin-1alpha, E-cadherin and N-cadherin, however do not show desirable effects.

The Notch proteins (Notch 1-4) are transmembrane receptors produced as long polypeptides that are modified by several proteolytic cleavages before activation to generate a fragment containing most of the extracellular domain and a fragment corresponding to the transmembrane domain extending into the cytoplasm. The fragments stay non-covalently bound to each other and are inserted into the cell membrane as heterodimers. Upon binding of ligand (i.e., Delta-like [D11]-1, -3, and -4, and Jagged-1 and -2), a second cleavage takes place in the extracellular domain in close proximity to the cell membrane. This cleavage is performed by a member of the a disintegrin and metalloprotease domain (ADAM) family of metalloproteases called TACE (tumor necrosis factor-a converting enzyme, also known as ADAM17) and is required for exposure of the S3 activating cleavage site. The S3 activating cleavage is performed by the so-called γ-secretase [The functional role of Notch signaling in human gliomas” by Marie-Thérése Stockhausen et. al in Neuro-Oncology Advance Access published Dec. 14, 2009].

It is further disclosed that small molecules can disrupt the binding of even highly disordered proteins, lacking alpha helices or beta pleated sheets at the binding domains. It is mentioned that a number of protein-protein interactions in the Notch pathway could be logical targets for disruption, including Notch—Notch ligand, Notch intracellular domain (NICD)—CBF1 transcription factor, or NICD—mastermind-like (MAML) [Notch Inhibition As a Promising New Approach To Cancer Therapy” by Benjamin Purow published in AdvExp Med Biol. 2012; 727: 305-319].

Furthermore, it is known from literature that hypoxia-inducible factor-1α (HIF-1α) can induce activation of Notch pathway which is essential for hypoxia-mediated maintenance of glioblastoma stem cell (GSC). Data suggests the role for HIF-1α in the interaction and stabilization of intracellular domain of Notch (NICD), and activation of Notch signalling.

Even though the merits of targeting the Notch pathway have raised numerous questions as certain imbalance of this pathway can impose long term side effects such as, gastrointestinal toxicity and diarrhoea, nevertheless, identification of suitable and alternative drugtargets for inhibition of this pathway in Glioblasotma is undoubtedly useful and effective tool for cancer therapy. It however requires the understanding of the exact mechanisms that are governing the normal functions of Notch signalling pathway in functional cells.

Numerous experiments on different regulations, cross talks of NOTCH pathway are reported in the literature to identify the probable drug targets/biomarkers but unfortunately, the integrations of these experimental findings have not been performed properly and none of the signalling pathway database provides this extensive and up to date information and hence it has become impossible to predict the consequence of the inhibition of this pathway in a diseased situation. Moreover, study of the effects of several drug targets from a population of large number of proteins is also difficult through in-vitro and in-vivo analysis.

In the recent past, computational approaches, bioinformatics tools have contributed immensely in understanding and analysis of large signalling pathways for identifying drug targets/biomarkers in the signalling pathway in the treatment of glioblastoma and varied grades of glioma tumour. However, very little work is done in developing a computational method for identifying the target molecules in NOTCH signalling pathway to treat glioma or cancer and the present inventors further observed that the databases relied upon for computational study even though provide the basic information of the pathway, core proteins and the connections among its associated proteins/molecules, which are involved in the Notch signal transduction network and also its functional cross talks with other cell signaling pathways, however there is no up to date Notch pathway information along with cross talk molecules of other pathways information to get a general structure of NOTCH network that can impact the treatment of glioma.

### SUMMARY OF THE INVENTION

In view of the above, it is an object of the present invention to provide an in-silico/computational method for identification of combinatorial oncoprotiens, as potential drug targets or oncoprotein biomarkers that inhibit the NOTCH pathway useful for the treatment of glioblastoma.

The other object of the invention is to construct a comprehensive NOTCH pathway that can help to identify combination of target oncoproteins or oncoprotein biomarkers for the treatment of glioblastoma.

Yet another object of the invention is to provide novel therapeutic strategy to inhibit the NOTCH pathway by targeting the combination of oncoproteins as probable drug targets identifying oncoprotein biomarkers in the treatment of Glioma or cancer.

The present invention provides a newly constructed, comprehensive, up to date and the largest human cell specific Notch signalling pathway by collating the available data from different literatures and experimental reports (Table 1). Different types of molecular reactions such as Physical interaction, Enzymatic reactions, Phosphorylation, Protein production, Activation, Inhibition, Nuclear translocation etc., were also considered to construct the pathway map.

The pathway data are selected from the databases KEGG, REACTOME, NETPATH, BIOCARTA, WIKI PATHWAYS etc. and other relevant databases (Table 1).

In an aspect, the present invention provides the NOTCH pathway comprising 115 molecules (96 core and 19 cross talking pathway molecules including proteins and organic compounds) and 231 molecular interactions/reactions (FIG. 1).

The computational study is based on using graph theoretical and logical analysis to model the reconstructed pathway and identify “Hub” proteins for alternative drug targets in place of GAMMA SECRETASE complex.

In a preferred aspect, the present invention provides an in-silico method to identify combinatorial oncoproteins in Notch pathway as potential drug targets that inhibit Notch pathway activity in Glioblastoma required to control or treat glioma in a subject comprising;
i. Reconstructing novel NOTCH pathway by collating proteins from the various databases;
ii. Simulating the logical models of Normal Notch Pathway scenario (NNS), Glioblastoma Scenario (GBS), Gamma Secretase Inhibitor Scenario (GSI) as well as drug treated scenarios (TS1 and TS2) in CellNetAnalyzer (a MATLAB package to perform Boolean analysis) to identify the combination of oncoproteins as potential drug targets involved in the abnormal activation of NOTCH pathway in the development of glioblastoma (FIG. 2).

The logical analysis of step (ii) comprises;
i. comparing computationally the number of upstream activator proteins of NOTCH1, NOTCH4, NICD1/2/3/4, HES1, HEY1, IAP, BCL2, FLIP, CCND1, CCND3 etc. selected from FIG. 3A; number of downstream proteins activated by the proteins NOTCH2, NOV, MAGP1, JAK2, STAT3, NUC_NICD1/2/3/4, CSL, YY1, WDR12 etc. selected from FIG. 3B; number of upstream inhibitor proteins of STAT3_P, PI3K, AKT, P53_P, CDK2, GATA3 etc. selected from FIG. 3C; and number of downstream proteins inhibited by the proteins Nuclear Co-repressor complex (COR), P53, CDK8, CYCC, HEY1 etc. selected from FIG. 3D of the glioblastoma scenario with each protein of the normal scenario.
ii. identifying the proteins with significant variations in cancer scenario with respect to the normal scenario; and
iii. selecting combinations of target proteins from step (ii) for glioblastoma scenario comprising NICD1 & HIF1A and NICD1 & MAML proteins and perturbing said combination of proteins in the treatment scenario to inhibit the expression of the output oncoproteins of the NOTCH pathway causing glioblastoma.

In another aspect, the present invention discloses the combination of oncoproteins, identified by the in-silico method of the present invention, which comprises the combination of NICD1 & HIF1A for partial suppression of the expressions of Notch pathway activity and combination of NICD1 & MAML oncoproteins for complete suppression of the NOTCH pathway activity in the treatment of glioblastoma.

In another aspect, the present invention provides an in-silico method to identify combinatorial oncoprotein biomarkers in Notch pathway comprising NICD1 & HIF1A for partial suppression and NICD1 & MAML proteins for complete suppression to treat human Glioblastoma as provided herein above.

### DESCRIPTION OF FIGURES

FIG. 1 relates to Reconstructed human cell specific Notch signaling pathway.

FIG. 2 relates expression of each protein of Notch signaling pathway in five different scenarios: mRNA expression profile of Gliblastoma cell line (GBE), Glioblastoma (GBS), Normal Notch Pathway (NNS), Gamma Secreatase inhibition (GSI), and Two proposed drug treated scenarios, TS2: NICD1 and MAML combinatorial inhibition, and TS1: NICD1 and HIF1A combinatorial inhibition. (A) The expression of the input proteins, and (B) The expression and simulation results of the intermediate and output proteins.

FIG. 3 relates to comparison between normal, glioblastoma, gamma secretase inhibition and two proposed drug target scenarios. NNS: Normal Notch Pathway; GBS:Glioblastoma Scenario; GSI: Gamma Secretase Inhibition; TS1: NICD1 and HIF1A combinatorial inhibition; TS2: NICD1 and MAML combinatorial inhibition. (A)Represents number of upstream activator molecules (Y-axis) activating the molecules (X-axis) representing significant variations (B) Represents number of downstreamactivated molecules (Y-axis) activated by the molecules (X-axis) representing significant variations (C) Represents number of upstream inhibitor molecules (Y-axis) inhibiting the molecules (X-axis) representing significant variations (D) Represents number of downstream inhibited molecules (Y-axis) inhibited by the molecules(X-axis) representing significant variations.

FIG. 4 relates the degree centrality value of each protein of Notch signaling network. (A), (B) and (C) show the IN-DEGREE, OUT-DEGREE and TOTAL-DEGREE values of each node respectively.

FIG. 5 relates the (A) Eigen vector, (B) Closeness and (C) Betweenness centrality values respectively of each protein of Notch signaling network.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

The terms “comprises”, “comprising”, or any other variations thereof, are intended to cover anon-exclusive inclusion, such that one or more processes or composition's or systems or methods proceeded by “comprises . . . a” does not, without more constraints, preclude the existence of other processes, sub-processes, composition, sub-compositions, minor or major compositions or other elements or other structures or additional processes or compositions or additional elements or additional features or additional characteristics or additional attributes.

### DEFINITIONS

For the purpose of this invention, the following terms will have the meaning as specified therein:

In-Degree (Kin): It refers the total number of nodes (activations or inhibitions) that aredirectly acting on a particular node in the network.

Out-Degree (Kota): The total number of interactions (activations or inhibitions) that are acting by a particular node on the other nodes in the network.

Degree (Ki): It refers the total number of in-degree and out-degree of a particular node.

Eigenvector centrality: It refers that a node in a network will be more central if it is connected to many central nodes in the network.

Betweenness centrality: It is the ratio of the number of shortest paths that pass through the node to the total number of shortest paths of all the nodes to all the other nodes. It signifies that how a node is important in the shortest paths of all the other nodes of the network.

Closeness centrality of a node: It is defined as the inverse of sum of the total length of the distances or shortest paths of that node to the other nodes. Therefore higher closeness centrality of a node implies the lower length of shortest paths to the all other nodes in the network and signifies how close a node is situated from the other nodes in the network.

Upstream Activator proteins: It defines the proteins which are present at the upstream of a protein and help to activate its expression.

Downstream Activated proteins: It defines the proteins which are present at the downstream of a protein and are activated or up regulated by the influence of that protein.

Upstream Inhibitor proteins: It defines the proteins which are present at the upstream of a Protein and inhibit or down regulate its expression.

Downstream Inhibited proteins: It defines the proteins which are present at the downstream of a protein and are inhibited or down regulated by the influence of that protein.

Logical Simulation & ON/OFF states: The reconstructed Notch Pathway interaction was transformed in terms of Logical/Boolean equations. In order to create different scenarios, the logical states (“0” as “OFF” or “1” as “ON”) of the proteins are changed.

UP regulation & Down regulation of Proteins: The UP regulation of any protein in the in silico simulation is considered as 1 or ON and the Down regulation of any protein is considered as 0 or OFF in the simulation.

Normal Notch Pathway Scenario (NNS): It defines the in-silico model of the normal Notch pathway activation process. To simulate this scenario, only the core Notch proteins (DLL 1/3/4, JAG 1/2, NOTCH 1/2/3/4, GAMMA SECRETASE, CSL, HAT, EP300 etc.) are considered. The Notch ligands (DLL 1/3/4 and JAG 1/2) and the Notch receptors (NOTCH 1/2/3/4) are set as 1 or Up regulated or ON state.

Glioblastoma Scenario (GBS): It defines the in-silico model of the Notch pathway activation process in Glioblastoma tumour cells. This scenario is created by considering the expression values (UP or DOWN regulated) of Notch pathway proteins taken from experimental microarray data.

Gamma Secretase Inhibition Scenario: It defines the in-silico treatment model of the GAMMA SECRETASE treated or suppressed scenario in Glioblastoma tumour cell scenario. This scenario is created by constitutively suppressed the expression (i.e. by considering the logical state as 0 or OFF) of GAMMA SECRETASE protein in the simulation process.

Treatment Scenario 1 and 2 (TS1 and TS2): It defines the in-silico treatment model of the predicted combinatorial targets (NICD1 & MAML and NICD1 and HIF1A) in Glioblastoma model, where the expression of GAMMA SECRETASE is kept as found in Glioblastoma scenario. TS1 refers the scenario where NICD1 and HIF1A are constitutively down regulated by considering their logical states as 0 or OFF, whereas TS2 scenario is created by considering the logical states of NICD1 and MAML as 0 or OFF.

In an embodiment, the present invention relates to an in-silico method for identification of combinatorial oncoproteins as potential drug targets in NOTCH pathway to suppress the human glioblastoma proliferation.

The present invention further relates to an in-silico method to identify oncoprotein biomarkers and their interactions in NOTCH pathway for treatment of glioblastoma.

The in-silico method for identification of combinatorial oncoproteins as potential drug targets or oncoprotein biomarkers in the NOTCH pathway is based on the newly, comprehensive, up to date constructed NOTCH pathway of the current invention.

To reconstruct a master pathway model of NOTCH signalling network, the present inventors used the core structure of NOTCH pathway available from the databases and collated additional information from different literatures and experimental reports. Further, in order to incorporate the new molecule or interaction, certain criteria were set which are as follows: the newly inserted molecules should have atleast one direct or indirect connection or interaction with the core Notch pathway molecules, all the newly inserted interactions should have at least one experimental evidence in a peer reviewed journal and all the molecules should be placed in the pathway map according to the specified locations i.e., extra-cellular and membrane region, cytoplasmic, nucleus and output.

Thus using graph theoretical and logical analysis, the present invention provides a comprehensive up to date and the largest human cell specific Notch signalling pathway from available data and collating the additional information from different literatures and experimental reports (Table 1). Different types of molecular reactions such as Physical interaction, Enzymatic reactions, Phosphorylation, Protein production, Activation, Inhibition, Nuclear translocation etc., were also considered to construct the pathway map.

In an embodiment, the present invention discloses novel, comprehensive, up-to-date NOTCH pathway comprising 115 molecules (96 core and 19 cross talking pathway molecules including proteins and organic compounds) and 231 molecular interactions.

The pathway data are selected from the databases KEGG, REACTOME, NETPATH, BIOCARTA, WIKI PATHWAYS etc. and other relevant databases (Table 1).

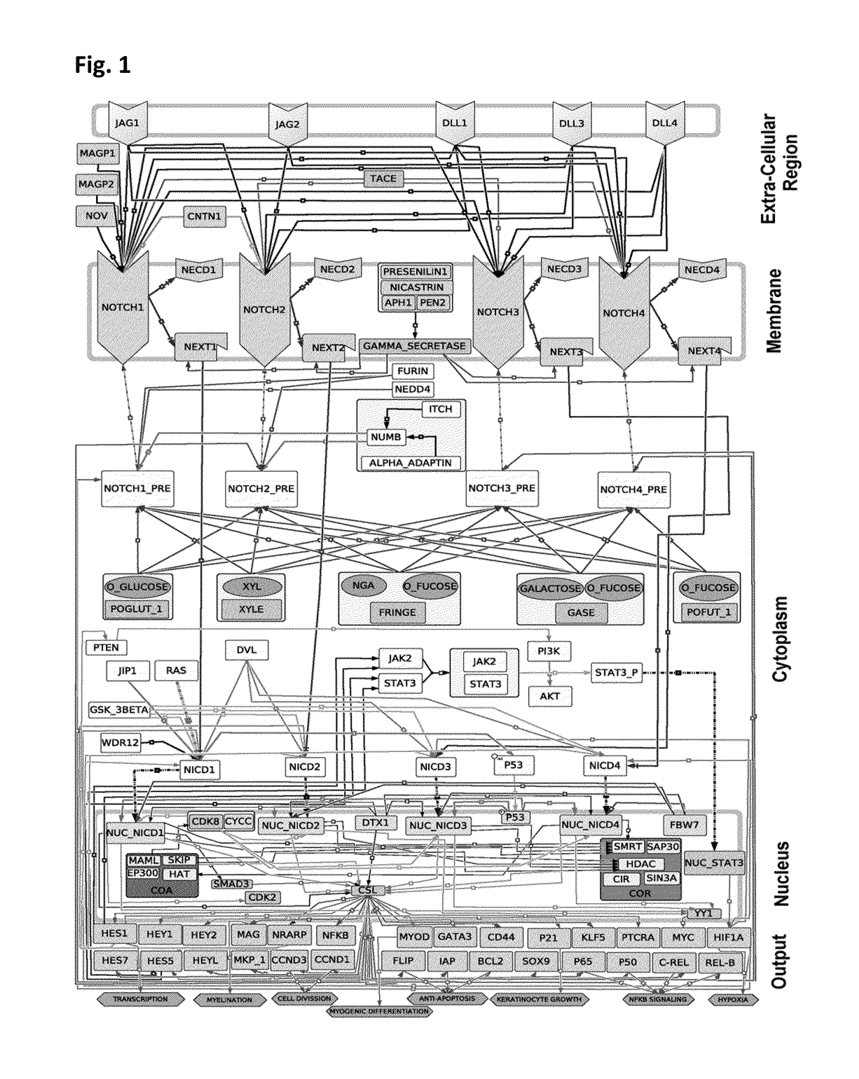

The new comprehensive NOTCH pathway (FIG. 1) is a master model that accounts for all the possible proteins and their interactions in different cell types across different experimental conditions. The pathway includes all the probable proteins and interactions that govern the flow of the signal, from input to intermediate to output layer.

A comparison between the newly reconstructed Notch pathway data (i.e., molecules and interactions) with the pathway information from other major biochemical signalling databases (e.g., KEGG, BIOCARTA, NETPATH etc.,) is presented in Table 2.

In an embodiment, the present invention employed the structural or topological analysis of NOTCH signalling pathway to identify the important proteins/molecules that form “Hub” molecules in the network based on the connectivity and centrality measurement parameters of the network such as Degree, Closeness, Betweenness, and Eigenvector centrality. The extracted proteins are enlisted in Table 3 below in the experimental section.

Accordingly, from the graph theoretical analysis proteins having high centrality values within the network are identified and includes ADAM/TACE, CSL, NICD1, MAML, HIF1A, NRARP, HES1, HES5 etc. (Table 3). Further, on the basis of the biological feasibility and the evidence of being used as targets in previous experiments, proteins which can be considered as probable drug targets for the current analysis were filtered out and include ADAM/TACE, NICD1, MAML, HIF1A and DLL4.

In another embodiment, the present invention relates to Logical analysis of the NOTCH pathway to test the effect of mutation or deregulation of important proteins in the network under certain circumstances as well as to identify the combinatorial oncoproteins or biomarkers of Notch pathway which were not identified by structural analysis.

The Logical analysis of Notch signaling network was performed to simulate the pathway activity and the expression of pathway proteins in Normal, Glioblastoma cell specific, Gamma Secretase inhibitor treatment and two proposed drug treated scenarios, and also to identify the logical relationship that exist among the proteins in the newly reconstructed Notch pathway and to analyze their regulations and expression patterns that vary according to the normal, disease and drug treated scenarios. The entire logical analysis of Notch pathway was performed using the logical relationships presented in the Table 4 as a master logical model.

In an aspect, the present invention validates the logical model of the GBS scenario by comparing the number of upstream activators genes/proteins in Glioblastoma Scenario (GB S) and Gamma Secretase Inhibitor Scenario (GSI) scenarios. It was observed that that the downstream activated proteins of several Notch pathway activator proteins such as JAG1/2, DLL1/3/4, MAGP1, NICD1 etc. were reduced by administering the GAMMA SECRETASE inhibition in GBS cell line.

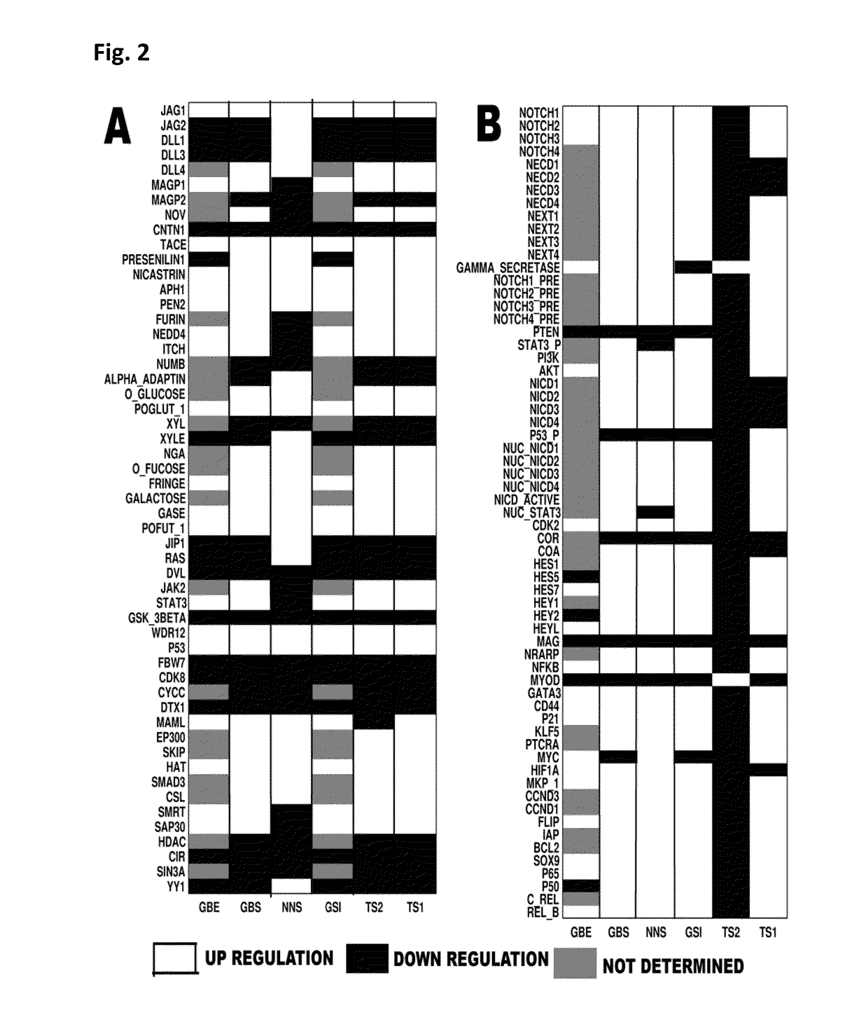

In a preferred embodiment, the present invention relates to an in-silico method to identify combinatorial oncoproteins in Notch pathway to treat human Glioblastoma, wherein said in-silico method comprises the steps of;
i. Reconstructing novel NOTCH pathway by collating proteins from the various databases; and
ii. simulating the logical models of Normal Notch Pathway scenario (NNS), Glioblastoma Scenario (GBS), Gamma Secretase Inhibitor Scenario (GSI) as well as drug treated scenario in Cell Net Analyzer to identify the combination oncoproteins as potential drug targets involved in the abnormal activation of NOTCH pathway in the development of glioblastoma (FIG. 2).

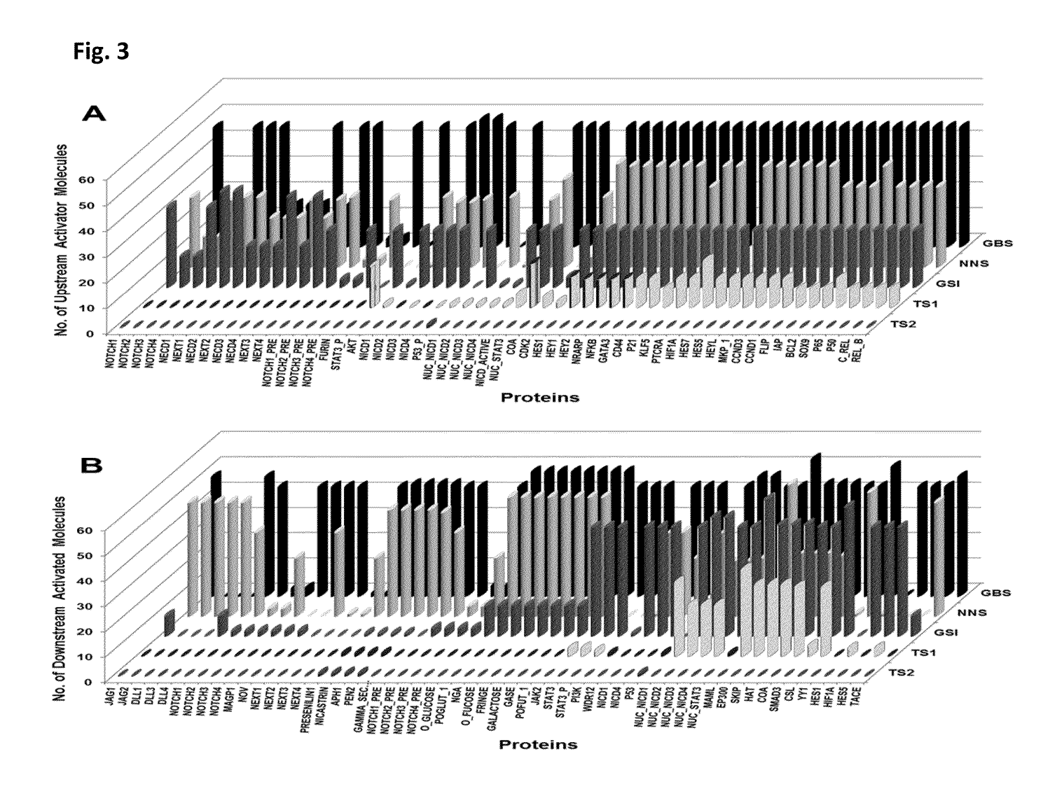

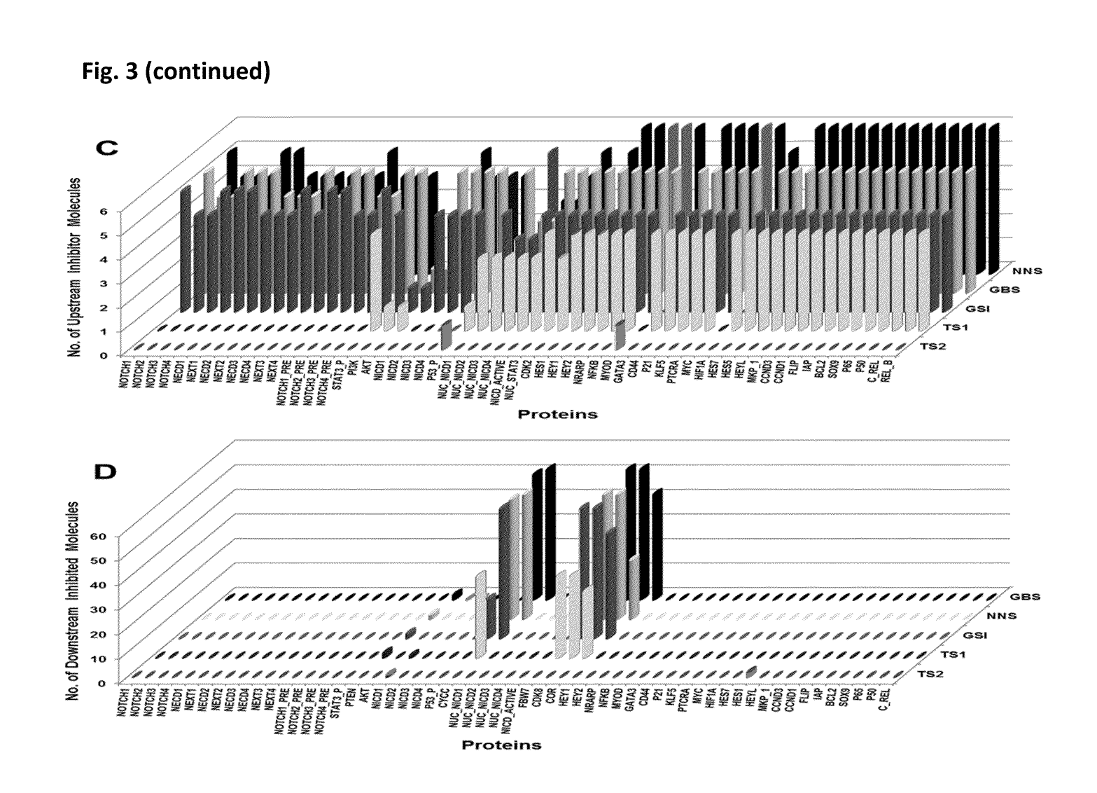

The logical analysis of step (ii) described above comprises;
i. comparing computationally the number of upstream activator proteins of NOTCH1, NOTCH4, NICD1/2/3/4, HES1, HEY1, IAP, BCL2, FLIP, CCND1, CCND3 etc. selected from FIG. 3A; number of downstream proteins activated by the proteins NOTCH2, NOV, MAGP1, JAK2, STAT3, NUC_NICD1/2/3/4, CSL, YY1, WDR12 etc. selected from FIG. 3B; number of upstream inhibitor proteins of STAT3_P, PI3K, AKT, P53_P, CDK2, GATA3 etc. selected from FIG. 3C; and number of downstream proteins inhibited by the proteins Nuclear Co-repressor complex (COR), P53, CDK8, CYCC, HEY1 etc. selected from FIG. 3D of the glioblastoma scenario with each protein of the normal scenario;
ii. identifying the proteins with significant variations in cancer scenario with respect to the normal scenario; and
iii. selecting combinations of target proteins from step (ii) for glioblastoma scenario comprising NICD1 & HIF1A and NICD1 & MAML proteins and perturbing said combination of proteins in the treatment scenario to inhibit the expression of the output oncoproteins of the NOTCH pathway causing glioblastoma.

Accordingly, using the master logical model and varying the logical states of the input molecules of the pathway, four different scenarios such as Normal Notch scenario (NNS), Glioblastoma, GAMMA SECRETASE inhibition, and two proposed in-silico combinatorial drug treated scenarios were simulated. In NNS, the core Notch pathway scenario was simulated by considering the inputs of only the expression of core proteins of Notch pathway. The Glioblastoma Scenario (GBS) was created by using the input of the expression values from mRNA expression data of Glioblastoma cell line. The rest of the three scenarios were created by using the same logical states of the inputs of GBS with additional alterations/perturbations of the logical states of the target proteins according to the need for the specific scenario and the respective simulated results of the output proteins were observed and are described in Table 5 and Table 6.

In step (i) of the logical analysis the Normal Notch scenario (NNS) and Glioblastoma Scenario (GBS) were compared computationally, where proteins which were abnormally getting activated or inhibited in Glioblastoma cell line compared to the normal scenario were identified. The network analysis allowed filtering out the possible drug target molecules from out of 115 molecules of the pathway. Further, several probable targets were identified through sole or combinations of proteins by perturbing the logical states of GBS model. Though the sole perturbation did not suppress the expressions of several NOTCH target proteins, however targeting these proteins in combination showed effective suppression of the expressions of several Notch target proteins. Among them the combination of NICD1 and HIF1A (TS1) was suitable for the partial blocking of Notch pathway activity whereas inhibition of NICD1 and MAML (TS2) was useful to completely suppress the pathway activity in glioblastoma.

Yet another embodiment of the present invention provides an in-silico method as described in the present invention, wherein the number of upstream activator proteins in the cancer scenario is greater than that of the normal scenario thereby effecting the expression of the output oncoproteins.

Yet another embodiment of the present invention provides an in-silico method as described in the present invention, wherein each target protein is assigned ‘0’ or ‘OFF’ to constitutively down regulate its activity (e.g. to suppress the activity of a protein throughout a simulation, herein the logical state of the protein is considered as ‘0’) and ‘1’ or ‘ON’ to constitutively over express or up regulate of the said protein.

The other embodiment of the present invention provides an in-silico method wherein the output oncoproteins comprises HES1, HES5, HEY1, HEY2, MAG, NRARP, NFKB, HES7, HEYL, MKP_1, CCND3, CCND1, MYOD, GATA3, CD44, P21, KLF5, PTCRA, MYC, HIF1A, FLIP, IAP, BCL2, SOX9, P65, P50, C-REL, REL-B.

Yet another embodiment of the present invention provides an in-silico method wherein the down regulation of output oncoproteins alters the phenotypic outcomes or cellular responses such as Transcription, myelination, cell-division, myogenic differentiation, anti-apoptosis, keratinocyte growth, NFKB signalling and hypoxia.

In another embodiment, the present invention discloses the combination of oncoproteins, identified by the in-silico method of the instant invention, which are useful to suppress the expressions of Notch target proteins partially comprising the combination of NICD1 & HIF1A and combination of NICD1 & MAML oncoproteins for complete suppression in the treatment of glioblastoma.

In another embodiment, the present invention provides for use of combinatorial oncoproteins to suppress the expressions of Notch target proteins partially comprising the combination of NICD1 & HIF1A and combination of NICD1 & MAML oncoproteins for complete suppression in the treatment of glioblastoma.

Yet another preferred embodiment of the present invention relates to an in-silico method to identify combinatorial oncoprotein biomarkers that inhibit the NOTCH pathway activity in glioma cell line required to control or treat glioma or cancer comprising;
i. Reconstructing novel NOTCH pathway by collating proteins from the various databases; and
ii. simulating the logical models of Normal Notch Pathway scenario (NNS), Glioblastoma Scenario (GBS), Gamma Secretase Inhibitor Scenario (GSI) as well as drug treated scenario in Cell Net Analyzer to identify the combination oncoproteins biomarkers involved in the abnormal activation of NOTCH pathway in the development of glioblastoma (FIG. 2).

The logical analysis of step (ii) described above comprises;
i. comparing computationally the number of upstream activator proteins of NOTCH1, NOTCH4, NICD1/2/3/4, HES1, HEY1, IAP, BCL2, FLIP, CCND1, CCND3 etc. selected from FIG. 3A; number of downstream proteins activated by the proteins NOTCH2, NOV, MAGP1, JAK2, STAT3, NUC_NICD1/2/3/4, CSL, YY1, WDR12 etc. selected from FIG. 3B; number of upstream inhibitor proteins of STAT3_P, PI3K, AKT, P53_P, CDK2, GATA3 etc. selected from FIG. 3C; and number of downstream proteins inhibited by the proteins Nuclear Co-repressor complex (COR), P53, CDK8, CYCC, HEY1 etc. selected from FIG. 3D of the glioblastoma scenario with each protein of the normal scenario;
ii. identifying the oncoprotein biomarkers with significant variations in cancer scenario with respect to the normal scenario; and
iii. selecting combinations of oncoprotein biomarkers from step (ii) for glioblastoma scenario comprising NICD1 & HIF1A for partial suppression and NICD1 & MAML proteins for complete suppression and perturbing said combination of proteins in the treatment scenario and thereby inhibiting the expression of the output oncoproteins of the NOTCH pathway causing glioblastoma.

The another embodiment of the present invention provides an in-silico method to identify novel combinatorial oncoprotein biomarkers as potential drug targets as described in the present invention, wherein the number of upstream activator proteins in the glioma or cancer scenario is greater than that of the normal scenario thereby effecting the expression of the output oncoproteins.

Yet another embodiment of the present invention for an in-silico method to identify novel combinatorial oncoproteins biomarkers as potential drug targets as described in the present invention, wherein each target protein is assigned ‘0’ or ‘OFF and ‘1’ or ‘ON’ to upregulate or down regulate the expression of said protein.

The other embodiment of the present invention provides for an in-silico method to identify combinatorial oncoproteins biomarkers as potential drug targets, wherein the output oncoproteins comprises HES1, HES5, HEY1, HEY2, MAG, NRARP, NFKB, HES7, HEYL, MKP_1, CCND3, CCND1, MYOD, GATA3, CD44, P21, KLF5, PTCRA, MYC, HIF1A, FLIP, IAP, BCL2, SOX9, P65, P50, C-REL, REL-B.

Yet another embodiment of the present invention provides for an in-silico method to identify combinatorial oncoproteins biomarkers as potential drug targets, wherein the down regulation of output oncoproteins alters the phenotypic outcomes or cellular responses such as Transcription, myelination, cell-division, myogenic differentiation, anti-apoptosis, keratinocyte growth, NFKB signalling and hypoxia.

In another embodiment, the present invention discloses the combination of oncoproteins biomarkers identified by the in-silico method of the instant invention, which are useful to suppress the expressions of Notch target proteins partially comprising the combination of NICD1 & HIF1A and combination of NICD1 & MAML oncoproteins for complete suppression in the treatment of glioblastoma.

Another embodiment of the present invention provides for biomarkers as described herein, wherein the biomarkers enable identification of combinatorial oncoproteins as potential drug targets of the NOTCH pathway for treatment of glioblastoma.

Further details of the method of identification of combinatorial oncoproteins as potential drug targets/biomarkers of the present invention will be apparent from the examples presented below. Examples presented are purely illustrative and are not limited to the particular embodiments illustrated herein but include the permutations, which are obvious as set forth in the description.

### EXAMPLES

### Example 1

### Experimental Methodology

1. Construction of NOTCH Signalling Pathway

A newly, comprehensive up to date and the largest human cell specific Notch signalling pathway (FIG. 1) was constructed from the various databases and literature sources and collating the additional information from different literatures and experimental reports (Table 1).The pathway map was drawn in CellDesigner Ver. 4.2, an open source “Systems Biology Marked Up Language” (SBML) based pathway illustrator software.

The molecules of the pathway were annotated according to their sub-cellular locations in the cell. For NOTCH pathway three sub-cellular locations were considered. These included Extracellular and Membrane, Cytoplasm and Nucleus of Notch signal “Receiver Cell”. Since NOTCH pathway is mostly activated by the ligands expressed by the neighbouring cells, another cell membrane of Notch signal “Transmitter cell” was also considered to allocate the ligands. Further, in between these two membranes regions, a place for extracellular region was also marked.

i. Extracellular and Membrane

In this region, 27 molecules including 4 Notch receptors (NOTCH1/2/3/4), 9 ligand molecules such as JAG1/2, DLL1/3/4, MAGP1/2, NOV, CNTN1, 6 proteolytic enzyme complex including TACE, GAMMA SECRETASE complex etc., and the truncated portions of four Notch receptors such as NEXT1/2/3/4 and NECD1/2/3/4 were annotated.

The ligand—receptor interactions in the membrane region are followed by the common proteolytic cleavage of NOTCH receptors and subsequent formation of Notch Extracellular Domain (NECD) and Notch Extracellular Truncated Protein (NEXT). The metalloprotease enzyme TACE catalyzes the ligand-receptor reaction to cleave the Notch receptors. NEXT1/2/3/4 is further cleaved by proteolytic enzyme GAMMA SECRETASE complex as depicted in FIG. 1.

ii. Cytoplasmic Region

In this region a total of 35 molecules were included out of which 5 molecules are metabolic compounds such as O-linked glucose, Xylose, O-linked Fucose, GALACTOSE, N-acetylglucosamine. Moreover, the cytoplasmic region (or specifically the Golgi body) also includes post translation modification of Notch precursor proteins such as NOTCH1_PRE, NOTCH2_PRE, NOTCH3_PRE and NOTCH4_PRE before they are expressed in the cell membrane.

The GAMMA SECRETASE mediated reaction in the membrane region where four NEXT proteins produced four homologues of Notch Intracellular Domains (NICD1/2/3/4) were translocated in the cytoplasmic region which further moved in the nucleus region. During the travel through the cytoplasmic region, NICD1 encounters various activator proteins such as RAS, GSK_3 BETA, WDR12 along with inhibitor proteins such asDVL, JIP1. The NOTCH precursors pass through several glycosylation or fucosylation reactions by Glucose, Galactose, Fucose and the enzymes POGLUT_1, FRINGE, GASE, POFUT_1 etc. These post translational modifications of Notch precursors increase the specificity of ligand receptors interactions, so that it can easily recognizeand interact with Notch ligands. Xylosylatin is also expressed in this region by Xylose with the help of the enzyme Xylosyltransferase (XYLE) which in turn reduces the specificity of NOTCH ligand bindings. The enzyme-substrate reactions are included in the present pathway and are shown in FIG. 1.

iii. Nuclear Region

The nuclear region includes 23 such proteins such as NICD1/2/3/4, CSL, SMAD3 etc. and 2 transcription complexes which include Co-activator (COA) and Co-repressor (COR) complex (FIG. 1).

In the nuclear region activated NICD1/2/3/4 enters and starts the transcription process. NICD initiates its transcription by binding with another transcription factor CSL, which in general forms a transcription repressor complex with another transcription Co-repressor complex (COR). It is a complex of SMRT, SAP30, HDAC, CIR, SIN3A proteins in the nucleus. The nuclear region also includes a protein complex (COA, a complex of the proteins MAML, SKIP, EP300 and HAT) which acts as a transcription co-activator of CSL to transcribe Notch targetgenes/proteins such as HES1, HES5, HEY1, HEY2, HEYL, BCL2, P65, NOTCH1/2/3/4 etc.

In addition to the above three sub-cellular locations, the Notch target proteins grouped as “Output” proteins was annotated. Accordingly, total of 28 proteins as target proteins (e.g. HES and HEY proteins) which belong to any sub-cellular locations depending on their functional activity were identified. These proteins were linked with their phenotypic and functional activities (e.g., Transcription, Myelination, Cell Division, Anti-Apoptosis, and Hypoxia etc). Further, the NOTCH pathway can also be activated through CONTACTIN/F3 (CNTN1) mediated interaction, which involves the use of DTX1 as a transcription co-activator to produce the output protein MAG which is involved in the oligodendrocyte maturation and myelination. To reduce the complexity any gene or mRNA in this pathway map were not considered.

iv. Cross Talks with Other Pathways

The NOTCH pathway of the instant invention was cross connected with different signalling pathways such as JAK/STAT, PTEN/PI3K/AKT, RAS/MAPK, TGFB/SMAD3, CYCLIN/CDK, HYPDXIA/HIF1A, BCL2/IAP/ANTI-APOPTOSIS and P65/P50/NFKB proteins mediated pathways. The cross talk molecules of other pathways were selected from those that had direct interaction/influence on the core proteins of NOTCH pathway.

v. Feedback Loops

In the constructed Notch pathway, several feedback loops were identified that regulate its activity in various cellular situations and environmental stimuli. A cyclic feedback loop between a core protein of Hypoxia, i.e. HIF1A, to the Notch pathway proteins NICD, HES1, and HES5 was determined It was observed that HIF1A activates NICD1/2/3/4 which in turn helps to produce HES1/5 and other Notch pathway target proteins, HES1/5 molecules stabilizes JAK2/STAT3 complex formation and subsequent production of Phosphorylated STAT3 (STAT3_P) and activates HIF1A protein. A double negative feedback loop was further determined in cross talk with P53 pathway, the phosphorylated P53 inhibits NUC_NICD1/2/3/4 for its further transcription; whereas the phosphorylation of P53 was blocked by NICD1/2/3/4 in cytoplasm.

Furthermore, production of Notch molecules contributed a strong positive feedback effect in the entire network. Another strong negative feedback loop formed by Notch-Regulated Ankyrin Repeat-containing Protein (NRARP) was also found. NRARP inhibits Notch regulated transcription factors NICD1/2/3/4 in the cytoplasm and reduces the active NICD into the nucleus to inhibit Notch regulated transcriptions.

Considering the feedback loops formed in various reactions of the NOTCH pathway involving NOTCH target proteins and the cross talk proteins it was observed that a molecule which has feedback regulations with the output proteins may increase its importance or influence in the network, even though it has lower number of connections in the network.

In view of the presence of feedback loops of proteins HIF1A and NRARP in the Notch pathway and significant Out-Degree and Total-Degree values, their importance in the network was observed to be increased.

2. Structural Analysis

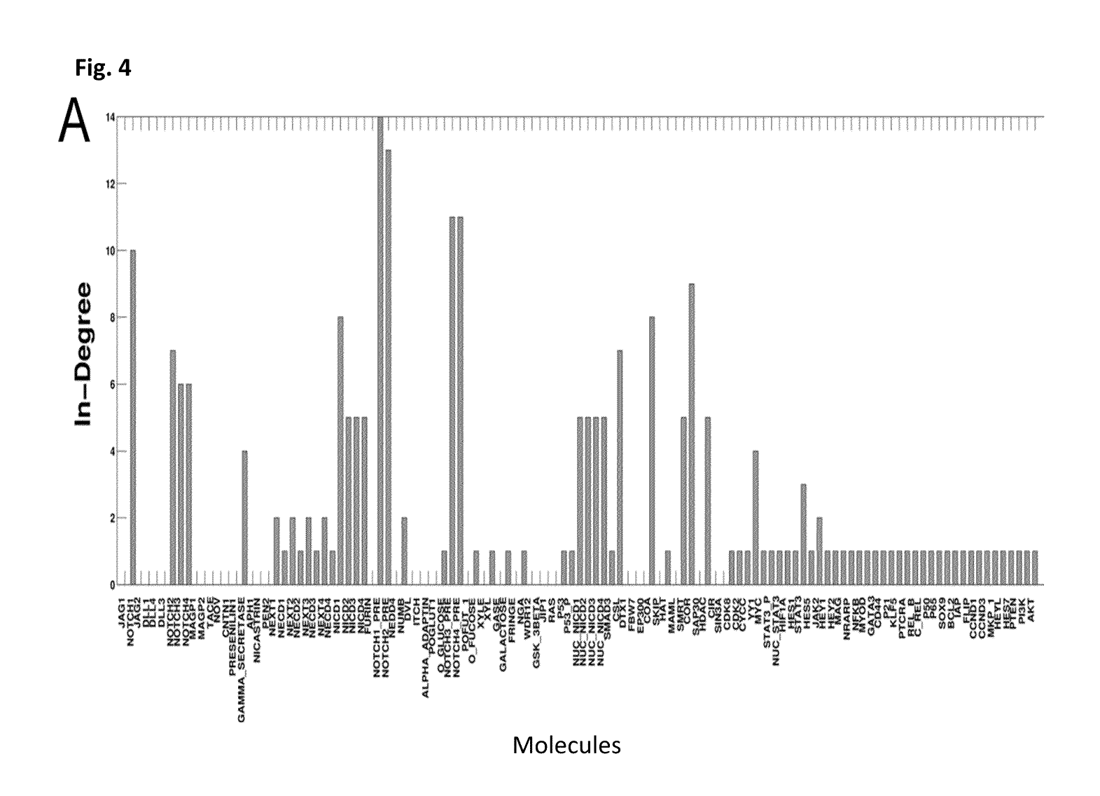

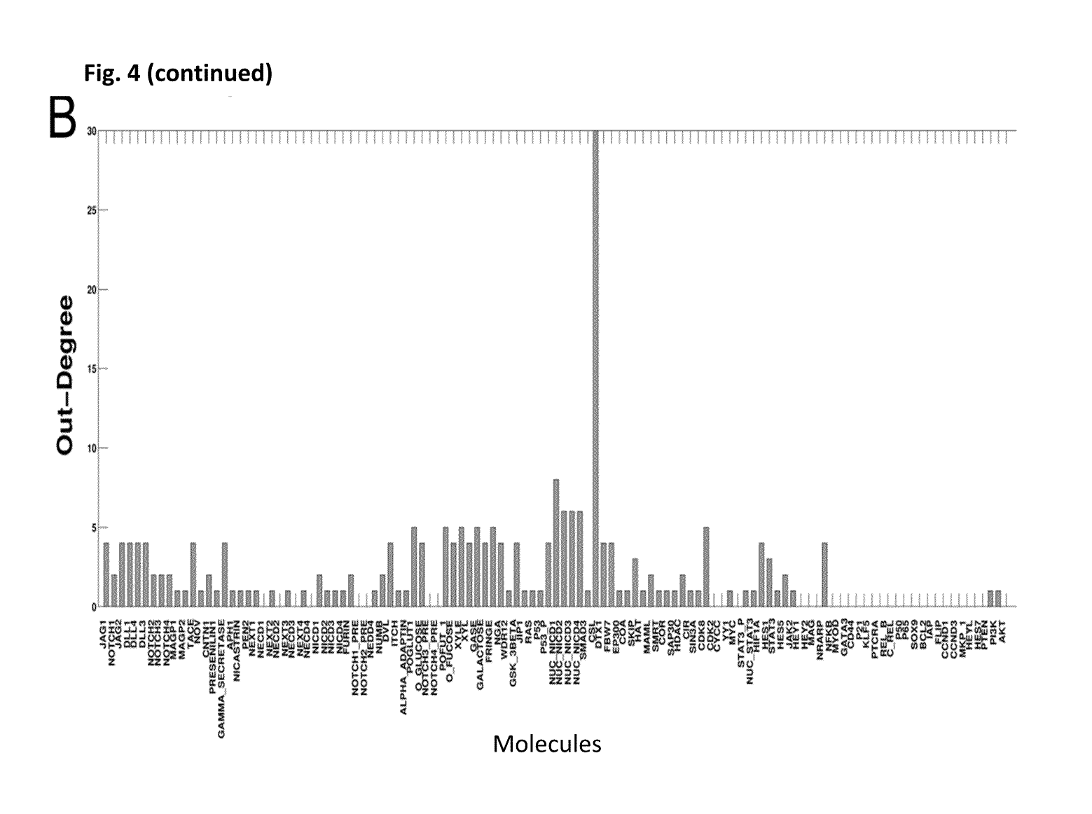

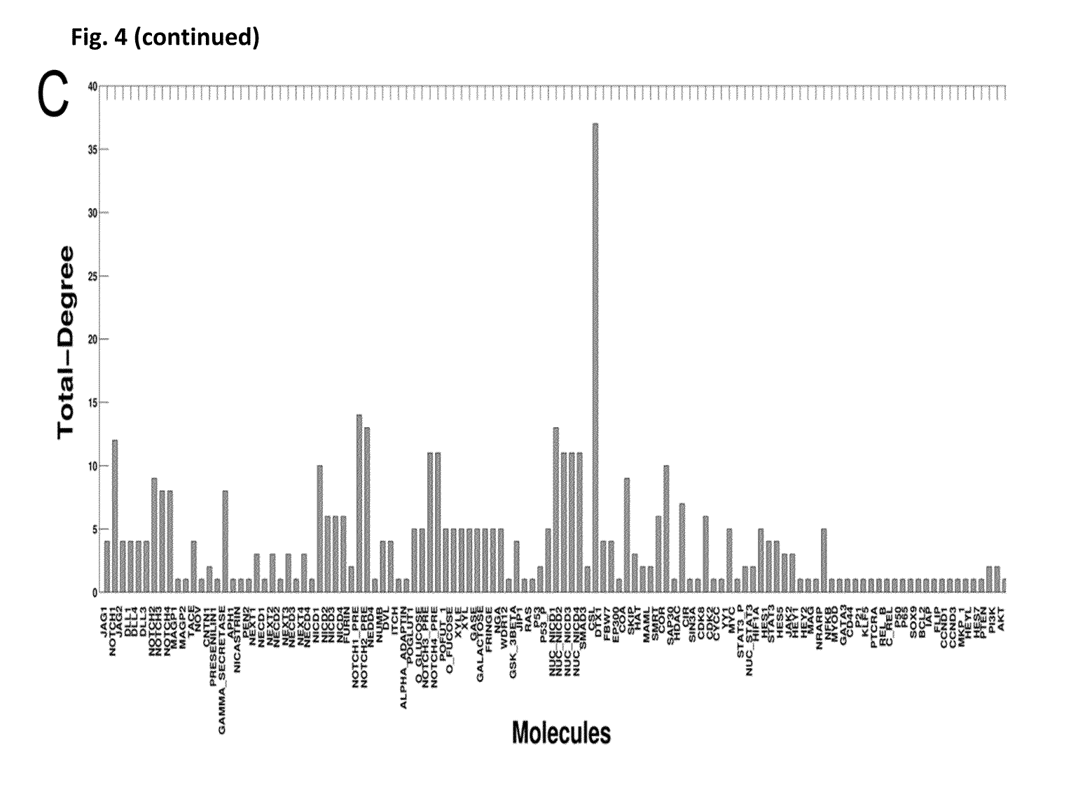

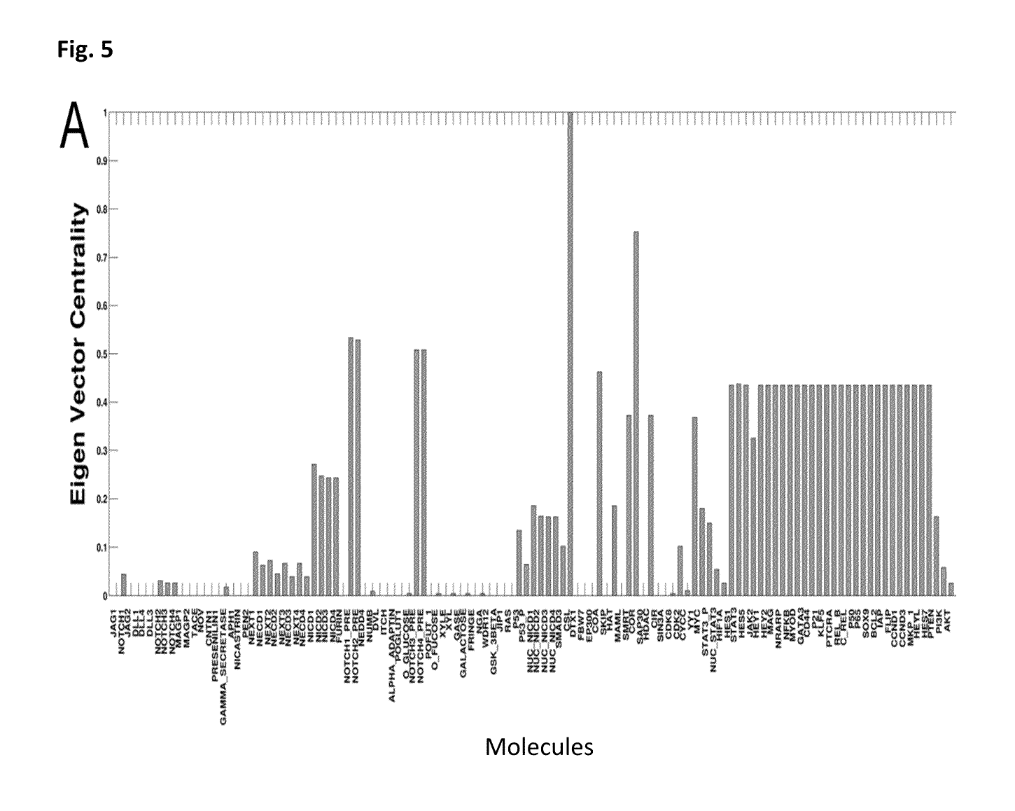

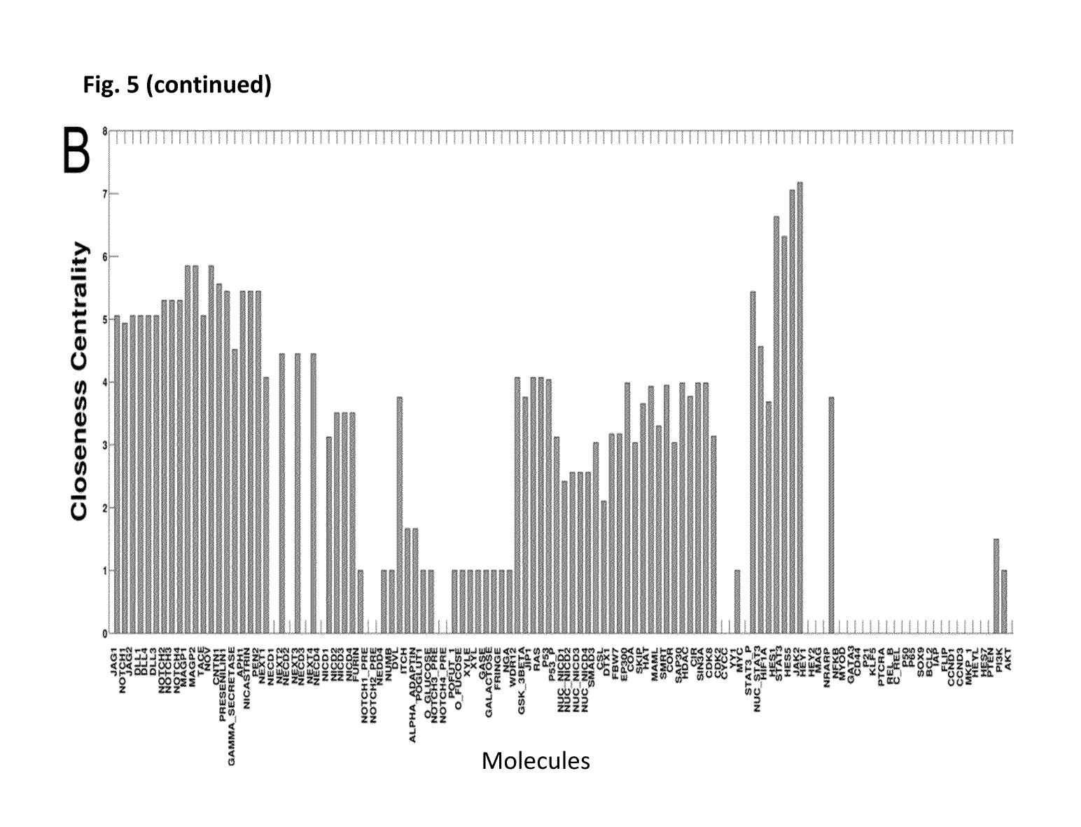

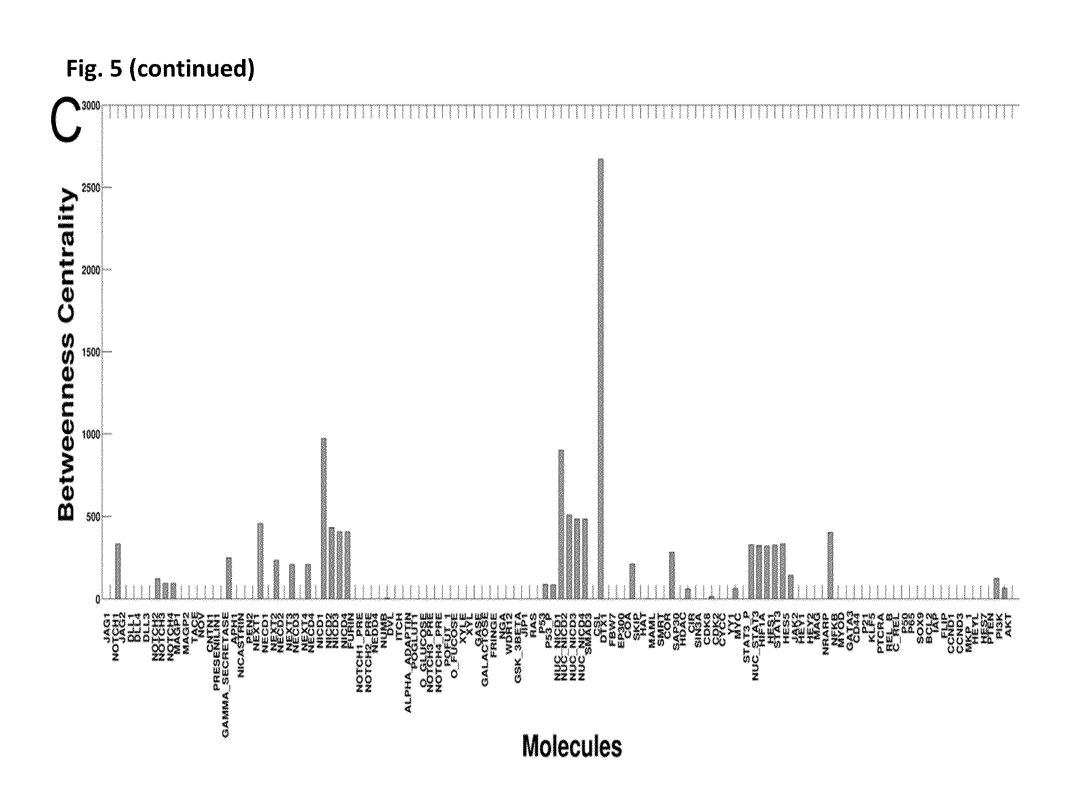

To find out the structure and topological features of the instant NOTCH signalling network, ‘Graph theory’ was used for analysis. The graph theoretical analysis was performed in open source software Gephi and igraph [Bastian M, Heymann S, Jacomy M (2009) Gephi: an open source software for exploring and manipulating networks. International AAAI Conference on Weblogs and Social Media; Csardi G, Nepusz T (2006) The igraph software package for complex network research, Inter Journal, Complex Systems 16951. In order to identify the central nodes in the network, four types of centrality analysis were performed i.e., Degree centrality, Eigen vector Centrality, Closeness Centrality and Betweenness Centrality, and these were calculated using the inbuilt algorithms implemented in these software applications. The degree centrality (in-degree, out-degree, total-degree) and the Eigen vector Centrality, Closeness Centrality and Betweenness Centrality parameter values for each node is plotted in FIGS. 4A-4C and FIGS. 5A-5C respectively.

To identify the important proteins from this heat plot on the basis of the connectivity parameters, the proteins were extracted which had parameter values higher than their corresponding average values.

The extracted proteins are enlisted in Table 3.

In case of In-Degree, all the four types of NOTCH receptors, NOTCH precursors and NOTCH Intracellular domains proteins showed high In-Degree values compared to the other proteins in the network (more than the average value, 1.97). Among the NOTCH receptor proteins, NOTCH1 had high values compared to the other homologues. Similarly, NOTCH1_PRECURSOR and NICD1 showed high values compared to their corresponding homologues present in the instant network. The high In-degree value signified the importance of NOTCH1 compared to all other homologues as higher number of incoming connections or interactions are regulating this protein in the network.

In case of Out-Degree data, the nuclear protein CSL showed highest number of Out-Degree value in the network as it was mostly connected with the output proteins of the network (more than the average value 1.97). Moreover, most of the ligands as well as the enzymes, including GAMMA_SECRETASE, and the Notch post translational modifier enzymes, such as POGLUT_1, POFUT_1, GASE, also showed significant number of Out-Degree values in the network, which also signifies that activation of Notch Pathway mostly occurred by the activation of these molecules in the network. Further, inhibitor molecules or complex, such as, Co-repressor complex (COR), HDAC, SMRT and the phosphorylated form of P53 (inhibitors of NUC_NICD1/2/3/4), also show significant number of Out-Degree values in the network. Among the output molecules of the instant network HIF1A and NRARP had significant Out-Degree and Total-Degree values, which were occurring because of the presence of feedback loops of these proteins in the network (FIG. 4).

### Centrality Measurements:

Centrality Values (Eigenvector, Closeness and Betweenness), are the most useful parameters, used to determine the relative importance of a node within a network.

Eigenvector centrality: The principle behind this parameter is that anode is considered as an important node if it is connected to the other important nodes in the network.

STAT3 showed significant Eigenvector centrality in the network although it had lower number of connectivity in the network (FIG. 5A). This was due to connectivity of STAT3 with HES1 and HES5, which also had high Eigenvector centrality in the network. Similarly the Eigenvector centrality of NICD1/2/3/4 was observed to increase due to its connections with the output proteins NRARP. The transcription co-repressor protein HADC and SMRT also showed higher value of Eigenvector centrality. The observations imply that a molecule which has feedback regulations with the output proteins may increase its influence in the network, even though it has lower number of connections in the network. The finding thus helps to identify the unknown feedback interactions of a particular protein in the network.

### Closeness Centrality:

Among all the individual molecules in the NOTCH pathway CSL showed the highest closeness centrality (average 0.002) value. NRARP, HIF1A, STAT3 also showed high Closeness centrality (FIG. 5B). The high closeness centrality value was due to the interaction of these proteins with other important proteins such as NICD1/2/3/4 or HES1/5 in the network. The high closeness centrality value of these proteins signifies that certain perturbations or mutations of these proteins can cause worst effect than the other proteins having lower closeness centrality values.

### Betweenness Centrality:

This parameter identifies the molecules on the basis of their position (the situation of a node which lies in between the shortest path of other two nodes) in the network, higher value of which signifies higher number of signalling cascades passing through a particular node implying that all biochemical reaction cascades in general prefer the shortest route to relay the signal in much more cost effective way.

Accordingly, CSL showed the highest Betweenness centrality value in the network as the production of all the output proteins was mediated by this protein. The inventors surprisingly observed that NICD1 showed higher Betweenness centrality value compared to its other homologues (i.e., NICD2/3/4). This was because, unlike the other three homologues of these proteins, NICD1 had extra three upstream regulators proteins: RAS, JIP1 and WDR12 as well as P53 protein in downstream. It is also connected with its nuclear counterpart NUC_NICD1, which has additional downstream target genes (e.g., BCL2, FLIP, IAP, P21, P65, P50, C_REL, REL_B) fort ranscription than its counterparts NUC_NICD2/3/4 (FIG. 5C). Hence, more number of shortest paths intersected this protein which enhanced the Betweenness centrality value.

3. Logical analysis of Notch signalling pathway:

The entire logical analysis of NOTCH pathway was performed using the logical relationships presented in the Table 4 as a master logical model. The Logical analysis was modelled in the entire pathway by creating five scenarios: Normal (NNS), Glioblastoma (GBS),GAMMA SECRETASE inhibition (GSI), Treatment scenarios by inhibiting NICD1 and HIF1A (TS1) and by inhibiting NICD1 and MAML (TS2). The expression scenarios generated in the simulation for each protein in the pathway is shown in FIG. 2.

GBE represents the expression of notch pathway proteins found in mRNA expression profile of Gliblastoma cell line collected from EBI-ARRAYEXPRESS database. The rest of the columns (GBS, NNS, GSI, TS1 and TS2) depict the in-silico simulation results for five different types of scenarios. FIG. 2A presents the expression of the input proteins which were considered to run the simulation, whereas FIG. 2B depicts the expression and simulation results of the intermediate and output proteins of the logical model of the instant invention.

The entire simulation of Boolean modelling was performed in CellNetAnalyzer and the following steps were followed during the logical simulation.
a. Selection of the states of input and output proteins
b. Simulation and perturbation using different logical states

### Perturbation Analysis and Model Validation

GAMMA SECRETASE inhibited Glioblastoma cell model (GSI) was created and simulated by considering the logical state of this protein as “0” or ‘OFF’ in our Glioblastoma cell model scenario (GBS).

Inhibiting the GAMMA SECRETASE enzyme in Glioblastoma cell line, the number of upstream activator and inhibitor molecules of the output proteins (HES1, HEY1, BCL2, IAP etc.) were reducing significantly as compared to the GBS (FIG. 3A and FIG. 3C). Further, it was observed that the in-silico simulation of GSI, by comparing the number of upstream activators genes/proteins in GBS and GSI scenarios, reduced the downstream activated proteins of several Notch pathway activator proteins (e.g., JAG1/2, DLL1/3/4,MAGP1, NICD1 etc.,) on administering the GAMMA SECRETASE inhibition in GBS cell line.

To validate the simulation result with experimental data, the inventors considered the previous experimental findings of DAPT, BMS-708163 and R04929097 (known GAMMA SECRETASE inhibitors) treated expressions profile of Notch pathway proteins in Glioblastoma cell line [A high Notch pathway activation predicts response to y secretase inhibitors in proneural subtype of glioma tumor initiating cells by Saito N et. al in Stem Cells published Jan. 3, 2014]. It showed that around 17 genes including the NOTCH pathway genes such as notch1, notch3, hes1, maml, dll3, jag2, etc., are active in the non-responder GAMMA SECRETASE inhibited cell populations as compared to the inhibitor responded cell populations. Similar results were obtained from in-silico simulation of GAMMA SECRETASE Inhibitor scenario (GSI) of the instant invention by comparing the number of upstream activators of the abovementioned genes/proteins in GBS and GSI scenarios (FIG. 3A). The results thus clearly validated the Logical model for GBS and GSI scenarios of the instant invention.

### Example 2

### Comparison Between Normal and Glioblastoma Scenario

To identify the proteins which were abnormally getting activated or inhibited in Glioblastoma cell line compared to the normal scenario, the present inventors simulated the model for both NOTCHpathway proteins in Normal (NNS) and Glioblastoma scenarios (GBS). The proteins were extracted which was causing glioblastoma by mutating the Notch signal and its associated molecules.

Accordingly, the logical states of the input proteins were considered as same as shown in FIG. 2 and the expression levels are as provided in Table 5 and Table 6. By calculating the dependency matrices for both the scenarios, significant variations of Upstream Activators, Upstream Inhibitors, Downstream Activated and Inhibited proteins for the proteins reported in the X-axis of FIG. 3 were identified.

The simulation result of Normal Notch pathway scenario (NNS) served as a control to measure the change in the expression level of Notch pathway molecules in Glioblastoma scenario.

The analysis indicated that different types of proteins from different sub-cellular locations showed significant changes (FIG. 3) in Glioblastoma scenario (GBS) compared to the Normal Notch pathway scenario (NNS). All the Notch target proteins (Oncoproteins) of Glioblastoma such as MAG, BCL2, MYOD etc. of GBS showed higher number of upstream activators as compared to the NNS (FIG. 3A). Similarly, the number of downstream activated proteins of Notch pathway (GAMMA_SECRETASE, WDR12, NICD1, NICD4, EP300, MAML, SKIP, HAT etc.,) also showed variations as compared to the NNS (FIG. 3B). It was also revealed that the downstream activator molecules of HES1, HES5 and HIF1A were increased from 0 to around 50 in GBS scenario. However, the number of downstream inhibited molecules of most of the molecules did not show significant variations in all the five scenarios (FIG. 3D), except for NUC_NCD1, FBW7, CDK8, COR and HEY1. Moreover, there was no significant variation in the number of downstream inhibited molecules for GBS, NNS and GSI scenarios.

### Example 3

### Drug Treated Perturbation Analysis

Since the sole perturbation of proteins did not give significant result, the inventors of the instant invention experimented different combination while doing the in-silico drug treated perturbation analysis. Accordingly, two drug treated scenarios were selected such as TS1 represents NICD1 and HIF1A combinatorial drug treated scenario and TS2 that represents the NICD1 and MAML treated scenario. Analysis revealed that TS1 scenario suppressed partially but comparably lower expressions of Notch target onco-proteins (BCL2, HES1, MAG, IAP etc.,) as compared to Glioblastoma as well as GAMMA SECRETASE Inhibitor scenario (GSI). On the other hand, in TS2 scenario, the expressions of the target onco-proteins were completely suppressed (FIG. 3). Thus, both the partial inhibition and complete suppression can be achieved by using TS1 and TS2 scenarios, respectively in Glioblastoma treatment.

Industrial Advantages:

The newly constructed and computational study of the human cell specific Notch signalling pathway provides an insight and complete understanding of the interactions between the signalling proteins in the pathway along with identification of alternative drug targets for Glioblastoma, where the pathway is known to become mutated. Further, comparing the cancer scenario with normal scenario, through novel and expansive constructed NOTCH signalling pathway and its computational study, the present invention provides a new therapeutic strategy to inhibit the NOTCH pathway by targeting combination of proteins selected from NICD1 & HIF1A or NICD1 & MAML as future drug targets. Accordingly, the present method successfully filters out the combination of proteins from the probable drug targets of NOCH pathway such as ADAM/TACE, CSL, NICD1, MAML, HIF1A, NRARP, HES1, HES5 etc. which had high centrality values within the network (Table 3) useful to completely suppress the pathway activity in the treatment of glioblastoma. The identified minimal combinations of proteins comprising of NICD1 & HIF1A and NICD1 & MAML may be used for further in-vitro and in vivo analysis as combinatory drug targets that opens up new avenue to control different cancers especially glioma and varied grades of glioma.

TABLE 1
List of databases used to reconstruct the Notch
signalling pathway and Glioma scenario

| | |
|---|---|
| Name of the Databases | Internet Link |

Cell Signalling Databases

| | |
|---|---|
| KEGG | On the world-wide web at: genome.jp/kegg/ |
| Signaling Pathway | On the world-wide web at: grt.kyushu-u.ac.jp/spad/ |
| Database (SPAD) | |
| GENEGO: Pathway Maps | On the internet at: pathwaymaps.com/maps/ |
| Biocarta | On the world-wide web at: biocarta.com/ |
| Protein Lounge | On the world-wide web at: proteinlounge.com/ |
| Millipore | On the world-wide web at: |
| | millipore.com/pathways/pw/pathways |
| Applied Biosystem | On the world-wide web at: |
| | appliedbiosystems.com/tools/pathway/ |
| Invitrogen | On the world-wide web at: |
| | invitrogen.com/site/us/en/home/Products-and- |
| | Services/Applications/Cell-Analysis/Signaling- |
| | Pathways.html |
| DOQCS | On the internet at: doqcs.ncbs.res.in/ |
| Reactome | On the world-wide web at: |
| | reactome.org/ReactomeGWT/entrypoint.html |
| Pathway Interaction | On the internet at: pid.nci.nih.gov/ |
| Database (PID) | |
| CPDB | On the internet at: cpdb.molgen.mpg.de/ |
| Netpath | On the world-wide web at: netpath.org/ |
| Pathway Commons | On the world-wide web at: pathwaycommons.org/about/ |
| Hipathdb | On the internet at: |
| | hipathdb.kobic.re.kr/browse.php?dbType=1 |
| Signalink | On the internet at: signalink.org/ |
| Spike | On the world-wide web at: cs.tau.ac.il/~spike/ |
| Wikipathways | On the internet at: |
| | wikipathways.org/index.php/WikiPathways |
| Innatedb | On the world-wide web at: innatedb.com/ |
| Inoh | On the world-wide web at: inoh.org/ |
| BioModels | On the world-wide web at: ebi.ac.uk/biomodels-main/ |
| GOLD.db | On the internet at: gold.tugraz.at/ |
| Cell Signaling Technology | On the world-wide web at: cellsignal.com/index.jsp |
| Biocompare | On the world-wide web at: biocompare.com |
| Pathway Central | On the world-wide web at: |
| | sabiosciences.com/pathway.php?sn=Hedgehog |
| Pathway Studio | On the world-wide web at: |
| | ariadnegenomics.com/products/pathway-studio |

Protein-Protein Interaction Databases

| | |
|---|---|
| HPRD | On the world-wide web at: hprd.org |
| APID | On the internet at: bioinfow.dep.usal.es/apid/index.htm |
| STRING 9.05 | On the internet at: string-db.org/ |
| PIPS | On the world-wide web at: compbio.dundee.ac.uk/www- |
| | pips/textSearch.jsp?searchTerm=notch1&page=1&division=25 |
| HIPPIE | On the internet at: cbdm.mdc-berlin.de/tools/hippie/ |
| BioGRID 3.2 | On the internet at: thebiogrid.org/ |

Microarray Expression Database

| | |
|---|---|
| EBI-ARRAYEXPRESS | On the world-wide web at: ebi.ac.uk/arrayexpress/ |
| Gene Expression Omnibus | On the world-wide web at: ncbi.nlm.nih.gov/geo/ |

Cancer Related Database

| | |
|---|---|
| NCG 4.0 | On the internet at: bio.ieo.eu/ncg/ |
| Cancer Resource | On the internet at: bioinf-data.charite.de/cancerresource/ |
| Cancer Cell Map | On the internet at: cancer.cellmap.org/ |

TABLE 2
Comparative statistics of number of species and interactions
for Notch pathway in different databases.

| Database Name | Molecules | Interactions |
|---|---|---|
| Our Reconstructed Pathway | 115 | 231 |
| KEGG | 24 | 15 |
| Biocarta | 7 | 10 |
| NetPath | 85 | 138 |
| Pathway Central | 16 | 11 |
| Cell Signaling Technology | 22 | 18 |
| Protein Lounge | 13 | 12 |

TABLE 3
Extracted significant proteins of Notch signaling pathway which have
higher parameter values than the corresponding average values.

| Network | Average | |
|---|---|---|
| parameters | value | Name of molecules |
| In-degree | 1.97 | NOTCH1, NOTCH2, NOTCH3, NOTCH4, |
| | | GAMMA_SECRETASE, NICD1, NICD2, NICD3, NICD4, |
| | | NOTCH1_PRE, NOTCH2_PRE, NOTCH3_PRE, |
| | | NOTCH4_PRE, NUC_NICD1, NUC_NICD2, NUC_NICD3, |
| | | NUC_NICD4, CSL, COA, SMRT, COR, HDAC, YY1, STAT3 |
| Out-degree | 1.97 | JAG1, JAG2, DLL1, DLL4, DLL3, TACE, |
| | | GAMMA_SECRETASE, DVL, POGLUT1, O_GLUCOSE, |
| | | POFUT_1, O_FUCOSE, XYLE, XYL, GASE, GALACTOSE, |
| | | FRINGE, NGA, GSK_3BETA, P53_P, NUC_NICD1, |
| | | NUC_NICD2, NUC_NICD3, NUC_NICD4, CSL, DTX1, FBW7, |
| | | SKIP, CDK8, HIF1A, HES1, NRARP. |
| Total-degree | 3.94 | NOTCH1, NOTCH2, NOTCH3, NOTCH4, |
| | | GAMMA_SECRETASE, NICD1, NICD2, NICD3, NICD4, |
| | | NOTCH1_PRE, NOTCH2_PRE, POGLUT1, O_GLUCOSE, |
| | | NOTCH3_PRE, NOTCH4_PRE, POFUT_1, O_FUCOSE, XYLE, |
| | | XYL, GASE, GALACTOSE, FRINGE, NGA, P53_P, |
| | | NUC_NICD1, NUC_NICD2, NUC_NICD3, NUC_NICD4, CSL, |
| | | COA, SMRT, COR, HDAC, CDK8, YY1, HIF1A, NRARP |
| Eigenvector | 0.20 | NICD1, NICD2, NICD3, NICD4, NOTCH1_PRE, NOTCH2_PRE, |
| centrality | | NOTCH3_PRE, NOTCH4_PRE, NUC_NICD1, COA, HAT, |
| | | SMRT, COR, HDAC, YY1, HES1, STAT3, HES5, JAK2, HEY1, |
| | | HEY2, MAG, NRARP, NFKB, MYOD, GATA3, CD44, P21, KLF5, |
| | | PTCRA, REL_B, C_REL, P50, P65, SOX9, BCL2, IAP, FLIP, |
| | | CCND1, CCND3, MKP_1, HEYL, HES7. |
| Closeness | 0.002 | JAG1, NOTCH1, JAG2, DLL1, DLL4, DLL3, NOTCH2, |
| centrality | | NOTCH3, NOTCH4, MAGP1, MAGP2, TACE, NOV, CNTN1, |
| | | PRESENILIN1, GAMMA_SECRETASE, APH1, NICASTRIN, |
| | | PEN2, NEXT1, NEXT2, NEXT3, NEXT4, NICD1, NICD2, |
| | | NICD3, NICD4, DVL, WDR12, GSK_3BETA, JIP1, RAS, P53, |
| | | P53_P, NUC_NICD1, NUC_NICD2, NUC_NICD3, NUC_NICD4, |
| | | SMAD3, CSL, DTX1, FBW7, EP300, COA, SKIP, HAT, MAML, |
| | | SMRT, COR, SAP30, HDAC, CIR, SIN3A, CDK8, STAT3_P, |
| | | NUC_STAT3, HIF1A, HES1, STAT3, HES5, JAK2, NRARP |
| Betweenness | 107.94 | NOTCH1, NOTCH2, GAMMA_SECRETASE, NEXT1, NEXT2, |
| centrality | | NEXT3, NEXT4, NICD1, NICD2, NICD3, NICD4, NUC_NICD1, |
| | | NUC_NICD2, NUC_NICD3, NUC_NICD4, CSL, COA, COR, |
| | | STAT3_P, NUC_STAT3, HIF1A, HES1, STAT3, HES5, NRARP, |
| | | PTEN. |

TABLE 4
Master Logical model used for Notch pathway simulation

| | |
|---|---|
| LOGICAL EQUATIONS | DOCUMENTATION |

INPUTS

| | |
|---|---|
| JAG1 | Input proteins of our logical model. |
| JAG2 | |
| DLL1 | |
| DLL3 | |
| DLL4 | |
| MAGP1 | |
| MAGP2 | |
| NOV | |
| CNTN1 | |
| PRESENILIN1 | |
| NICASTRIN | |
| APH1 | |
| PEN2 | |
| FURIN | |
| NEDD4 | |
| ITCH | |
| NUMB | |
| ALPHA_ADAPTIN | |
| O_GLUCOSE | |
| POGLUT_1 | |
| XYL | |
| XYLE | |
| NGA | |
| O_FUCOSE | |
| FRINGE | |
| GALACTOSE | |
| GASE | |
| POFUT_1 | |
| JIP1 | |
| RAS | |
| DVL | |
| JAK2 | |
| STAT3 | |
| GSK_3BETA | |
| WDR12 | |
| P53 | |
| FBW7 | |
| CDK8 | |
| CYCC | |
| DTX1 | |
| MAML | |
| EP300 | |
| SKIP | |
| HAT | |
| SMAD3 | |
| CSL | |
| SMRT | |
| SAP30 | |
| HDAC | |
| CIR | |
| SIN3A | |
| YY1 | |
| TACE | |
| NICD_ACTIVE | |

INTERMEDIATE REACTIONS

| | |
|---|---|
| JAG1 + NOTCH1 + TACE = NECD1 | NOTCH receptors (NOTCH1, NOTCH2, |
| JAG1 + NOTCH1 + TACE = NEXT1 | NOTCH3, NOTCH4) bind with membrane bound |
| JAG1 + NOTCH2 + TACE = NECD2 | ligand JAG1. Followed by this interaction, a |
| JAG1 + NOTCH2 + TACE = NEXT2 | metallo-protease enzyme TACE (TNFalpha- |
| JAG1 + NOTCH3 + TACE = NECD3 | converting enzyme) cleaves the NOTCH receptors |
| JAG1 + NOTCH3 + TACE = NEXT3 | and produces NECD (Notch extracellular domain |
| JAG1 + NOTCH4 + TACE = NECD4 | 1) and NEXT (Notch Extra cellular Truncated |
| JAG1 + NOTCH4 + TACE = NEXT4 | Protein). |
| JAG2 + NOTCH1 + TACE = NECD1 | NOTCH receptors (NOTCH1, NOTCH2, |
| JAG2 + NOTCH1 + TACE = NEXT1 | NOTCH3, NOTCH4) bind with membrane bound |
| JAG2 + NOTCH2 + TACE = NECD2 | ligand JAG2. Followed by this interaction, a |
| JAG2 + NOTCH2 + TACE = NEXT2 | metallo-protease enzyme TACE (TNFalpha- |
| JAG2 + NOTCH3 + TACE = NECD3 | converting enzyme) cleaves the NOTCH receptors |
| JAG2 + NOTCH3 + TACE = NEXT3 | and produces NECD (Notch extracellular domain |
| JAG2 + NOTCH4 + TACE = NECD4 | 1) and NEXT (Notch Extra cellular Truncated |
| JAG2 + NOTCH4 + TACE = NEXT4 | Protein). |
| DLL1 + NOTCH1 + TACE = NECD1 | NOTCH receptors (NOTCH1, NOTCH2, |
| DLL1 + NOTCH1 + TACE = NEXT1 | NOTCH3, NOTCH4) bind with membrane bound |
| DLL1 + NOTCH2 + TACE = NECD2 | ligand DLL1. Followed by this interaction, a |
| DLL1 + NOTCH2 + TACE = NEXT2 | metallo-protease enzyme TACE (TNFalpha- |
| DLL1 + NOTCH3 + TACE = NECD3 | converting enzyme) cleaves the NOTCH receptors |
| DLL1 + NOTCH3 + TACE = NEXT3 | and produces NECD (Notch extracellular domain |
| DLL1 + NOTCH4 + TACE = NECD4 | 1) and NEXT (Notch Extra cellular Truncated |
| DLL1 + NOTCH4 + TACE = NEXT4 | Protein). |
| DLL3 + NOTCH1 + TACE = NECD1 | NOTCH receptors (NOTCH1, NOTCH2, |
| DLL3 + NOTCH1 + TACE = NEXT1 | NOTCH3, NOTCH4) bind with membrane bound |
| DLL3 + NOTCH2 + TACE = NECD2 | ligand DLL3. Followed by this interaction, a |
| DLL3 + NOTCH2 + TACE = NEXT2 | metallo-protease enzyme TACE (TNFalpha- |
| DLL3 + NOTCH3 + TACE = NECD3 | converting enzyme) cleaves the NOTCH receptors |
| DLL3 + NOTCH3 + TACE = NEXT3 | and produces NECD (Notch extracellular domain |
| DLL3 + NOTCH4 + TACE = NECD4 | 1) and NEXT (Notch Extra cellular Truncated |
| DLL3 + NOTCH4 + TACE = NEXT4 | Protein). |
| DLL4 + NOTCH1 + TACE = NECD1 | NOTCH receptors (NOTCH1, NOTCH2, |
| DLL4 + NOTCH1 + TACE = NEXT1 | NOTCH3, NOTCH4) bind with membrane bound |
| DLL4 + NOTCH2 + TACE = NECD2 | ligand DLL4. Followed by this interaction, a |
| DLL4 + NOTCH2 + TACE = NEXT2 | metallo-protease enzyme TACE (TNFalpha- |
| DLL4 + NOTCH3 + TACE = NECD3 | converting enzyme) cleaves the NOTCH receptors |
| DLL4 + NOTCH3 + TACE = NEXT3 | and produces NECD (Notch extracellular domain |
| DLL4 + NOTCH4 + TACE = NECD4 | 1) and NEXT (Notch Extra cellular Truncated |
| DLL4 + NOTCH4 + TACE = NEXT4 | Protein). |
| NEXT1 + GAMMA_SECRETASE = NICD1 | Notch extracellular truncated domains (NEXT1, |
| NEXT2 + GAMMA_SECRETASE = NICD2 | NEXT2, NEXT3 and NEXT4) are cleaved by |
| NEXT3 + GAMMA_SECRETASE = NICD3 | intracellular proteolytic enzyme called |
| NEXT4 + GAMMA_SECRETASE = NICD4 | Gamma_Secretase and produces Notch |
| | intracellular domains NICD1, NICD2, NICD3 and |
| | NICD4. |
| PRESENILIN1 + NICASTRIN + APH1 + | The component proteins of |
| PEN2 = GAMMA_SECRETASE | GAMMA_SECRETASE are PRESENILIN1, |
| | NICASTRIN, APH1 and PEN2. A charged |
| | aspartate in 19 residues long trans-membrane |
| | domain of PRESENILIN1 helps to stabilize the |
| | GAMMA_SECRETASE enzyme complex. |
| MAGP1 + NOTCH1 = NEXT1 | MAGP1 and MAGP2 proteins, present on |
| MAGP1 + NOTCH1 = NECD1 | microfibrils can interact with NOTCH1 and form |
| MAGP2 + NOTCH1 = NEXT1 | NEXT1 and NECD1 by a furin-like cleavage |
| MAGP2 + NOTCH1 = NECD1 | without the help of TACE metallo protease |
| | enzyme. |
| NOV + NOTCH1 = NEXT1 | Nephroblastoma overexpressed protein (NOV) |
| NOV + NOTCH1 = NECD1 | associates with NOTCH1 and induces the |
| | subsequent release of Notch extracellular proteins |
| | (NEXT1 and NECD1). |
| CNTN1 + NOTCH1 = NECD1 | Trans-extracellular interaction between |
| CNTN1 + NOTCH1 = NEXT1 | F3/Contactin (CNTN1) and NOTCH1 or NOTCH2 |
| CNTN1 + NOTCH2 = NEXT2 | can trigger the notch signaling pathway. |
| CNTN1 + NOTCH2 = NECD2 | |
| FURIN + !NUMB + !ITCH + | During maturation procedures, pre-processed |
| ALPHA_ADAPTIN + NOTCH1_PRE = | NOTCH1 and NOTCH2 molecules |
| NOTCH1 | (NOTCH1_PRE and NOTCH2_PRE) are cleaved |
| FURIN + !NUMB + !ITCH + | by FURIN like protease and form the processed |
| ALPHA_ADAPTIN + NOTCH2_PRE = | NOTCH molecules (NOTCH1 and NOTCH2) for |
| NOTCH2 | further ligand binding and signal transduction. |
| | Onco suppressor protein NUMB, with the help of |
| | ITCH or ALPHA_ADAPTIN, promotes the |
| | degradation of NOTCH1_PRE and NOTCH2_PRE |
| | (but not NOTCH3_PRE or NOTCH4_PRE) by |
| | recruiting the E3 ubiquitin ligase. |
| !NEDD4 + NOTCH1_PRE = NOTCH1 | Pre-processed NOTCH1 (NOTCH1_PRE) is the |
| | direct target of ubiquitin-protein ligase NEED4. |
| | Overexpression of NEDD4 in atrophy muscle cell |
| | cause down-regulation of NOTCH1 as |
| | ubiquitination causes rapid degradation of pre- |
| | processed NOTCH1. |
| GSK_3BETA + !DVL + !JIP1 + NICD1 = | GSK_3BETA phosphorylates NICD and then |
| NUC_NICD1 | phosphorylated NICD goes into the nucleus for |
| GSK_3BETA + !DVL + !JIP1 + NICD2 = | further transcription process. For simplicity the |
| NUC_NICD2 | phosphorylated NICD are not considered in this |
| GSK_3BETA + !DVL + !JIP1 + NICD3 = | model. On the other hand it has also been found |
| NUC_NICD3 | that DVL, JIP1 and P53 proteins can also exert |
| GSK_3BETA + !DVL + !JIP1 + NICD4 = | inhibitory effect on Notch intracellular domains in |
| NUC_NICD4 | cytoplasm (NICD1, NICD2, NICD3 and NICD4). |
| RAS + NICD1 = NUC_NICD1 | Experimental findings have proven the cross talk |
| | between RAS/MAPK pathways with NOTCH1 |
| | intracellular domains. This cross talk results the |
| | activation of Notch pathway in various cancer cell |
| | line including Glioma, Breast cancer etc. |
| !P53_P + NUC_NICD1 + CSL = NOTCH1_PRE | P53 the tumor suppressor protein has found to be |
| !P53_P + NUC_NICD2 + CSL = NOTCH2_PRE | the suppressor of NOTCH proteins in Glioblastoma |
| !P53_P + NUC_NICD3 + CSL = NOTCH3_PRE | cell line. P53 have been considered as the |
| !P53_P + NUC_NICD4 + CSL = NOTCH4_PRE | transcription represser of NUC_NICD and CSL |
| | and thus reducing the concentration of NOTCH |
| | precursor proteins. |
| P53 + !NICD1 = P53_P | Activated NOTCH1 (or NICD1) interacts with P53 |
| | and inhibits its phosphorylation. |
| WDR12 + NICD1 = NUC_NICD1 | WD-repeat protein contains NLS sequence has |
| | been found to interact with Notch1 intracellular |
| | domain (NICD1). Although the end result of this |
| | interaction is still not known, but it is quite |
| | intuitive that WDR12 may help to the nuclear |
| | translocation of NICD1 from cytoplasm and |
| | thereby modulate NOTCH signaling pathway. |
| !FBW7 + NICD4 = NUC_NICD4 | FBW7 expressed in mouse embryo is found to |
| | negatively regulate the NOTCH4-HEY1 dependent |
| | pathway. The FBW7 degrades intracellular domain |
| | of NOTCH4 through its ubiquitin ligase mediated |
| | activity. |
| POGLUT_1 + O_GLUCOSE + NOTCH1_PRE = | Post-translational modification of NOTCH |
| NOTCH1 | precursor proteins with O-linked glucose |
| POGLUT_1 + O_GLUCOSE + NOTCH2_PRE = | (O_GLUCOSE) molecule by Protein O- |
| NOTCH2 | glucosyltransferase −1 is a conserved process. This |
| POGLUT_1 + O_GLUCOSE + NOTCH3_PRE = | modification is found to be required for NOTCH |
| NOTCH3 | pathway activation and ligand binding. |
| POGLUT_1 + O_GLUCOSE + NOTCH4_PRE = | |
| NOTCH4 | |
| XYL + O_GLUCOSE + !XYLE + NOTCH1_PRE = | Addition of Xylose (XYL) molecule to the O- |
| NOTCH1 | GLUCOSE linked NOTCH precursor proteins is |
| XYL + O_GLUCOSE + !XYLE + NOTCH2_PRE = | mediated by an enzyme Xylosyltransferase |
| NOTCH2 | (XYLE). Loss or gain of function of XYLE has |
| XYL + O_GLUCOSE + !XYLE + NOTCH3_PRE = | strongly suggested that Xylose modification is |
| NOTCH3 | negatively correlated with the notch pathway |
| XYL + O_GLUCOSE + !XYLE + NOTCH4_PRE = | activation. |
| NOTCH4 | |
| O_FUCOSE + NGA + FRINGE + POFUT_1 + | FRINGE catalyses the addition of N- |
| NOTCH1_PRE = NOTCH1 | acetylglucosamine (NGA) to O-fucose in NOTCH |
| O_FUCOSE + NGA + FRINGE + POFUT_1 + | precursor proteins. NGA modification plays |
| NOTCH2_PRE = NOTCH2 | positive role for ligand receptor binding in Notch |
| O_FUCOSE + NGA + FRINGE + POFUT_1 + | signaling pathway. Fucosylation of Notch |
| NOTCH3_PRE = NOTCH3 | molecules is mediated by the enzyme POFUT_1 |
| O_FUCOSE + NGA + FRINGE + POFUT_1 + | (GDP-fucose protein O-fucosyltransferase 1). |
| NOTCH4_PRE = NOTCH4 | |
| GALACTOSE + GASE + O_FUCOSE + | GALACTOSE addition to O_FUCOSE linked |
| NOTCH1_PRE = NOTCH1 | Notch precursors molecules are mediated by the |
| GALACTOSE + GASE + O_FUCOSE + | enzyme GASE (Galactosyltransferase). |
| NOTCH2_PRE = NOTCH2 | |
| GALACTOSE + GASE + O_FUCOSE + | |
| NOTCH3_PRE = NOTCH3 | |
| GALACTOSE + GASE + O_FUCOSE + | |
| NOTCH4_PRE = NOTCH4 | |
| NUC_NICD1 + YY1 = MYC | NUC_NICD1 interacts directly with YY1 |
| | transcription factor and regulates the expression of |
| | MYC protein. |
| NUC_NICD1 + SMAD3 + CSL = HES1 | NUC_NICD1 and SMAD3 are seen to interact |
| | directly and thereafter regulate the expression of |
| | HES1 through CSL. |
| HDAC + SAP30 + CIR + SIN3A + SMRT = COR | On the other hand, the proteins HDAC, SMRT, |
| | CIR, SAP30, SIN3A forms a co-repressor complex |
| | (COR) of CSL which in turn regulates the |
| | expression of Notch target genes. |
| EP300 + MAML + HAT + SKIP = COA | In order to reduce the complexity of the model, a |
| NUC_NICD1 = NICD_ACTIVE | dummy node NICD_ACTIVE has been considered |
| NUC_NICD2 = NICD_ACTIVE | in place of all NUC_NICD1, 2, 3 and 4. This |
| NUC_NICD3 = NICD_ACTIVE | dummy species is not shown in the main figure. |
| NUC_NICD4 = NICD_ACTIVE | Transcription co-activator complex (COA), |
| NICD_ACTIVE + CSL + !COR + COA = | consisting of CSL, NICD, Mastermind (MAML), |
| HES1/HES5/HES7/HEY1/HEY2/HEYL/ | EP300 and histone acetyltransferase (HAT) induces |
| GATA3/CCND3/CCND1/CD44/KLF5/SOX9/ | the transcriptional activation of several Notch |
| PTCRA/MKP_1/NFKB/ | target genes, such as HES1, HES5, HES7, HEY1, |
| | HEY2, HEYL, GATA3, CCND1, CCND3, CD44, |
| | KLF5, SOX9, and NFKB. |
| NUC_NICD1 + COA + CSL + !COR = BCL2/ | Nuclear NICD1 (NUC_NICD1) has found to |
| FLIP/IAP/P21/P65/P50/C_REL/REL_B | activate the anti-apoptosis proteins BCL2, FLIP, |
| | IAP as well as other NFkB pathway proteins P65, |
| | P50, C_REL, and REL_B. It also induces the |
| | expression of growth arrest factor P21 in primary |
| | differentiating keratinocytes cell lines. |
| NUC_NICD1/2 + DTX1 + CSL + !COR + COA = | F3/contactin trans-extracellular ligand dependent |
| MAG | NOTCH pathway promotes oligodendrocyte |
| | precursor cell differentiation and upregulates the |
| | myelin-related protein MAG. NOTCH1/2 and |
| | DTX1 mediated signaling cascade with the help of |
| | transcription factor CSL induces the transcription |
| | of MAG in OLN-93 cell line. |
| !HES1 = MYOD | Ligand-induced Notch signaling in myeloma cell |
| | up-regulates HES1 mRNA expression and |
| | subsequently reduced expression of MYOD. |
| MAML + !CDK8 + !CYCC + !FBW7 = | MAML directly interacts with CDK8 and recruits it |
| NUC_NICD1/2/3/4 | to hyper-phosphorylate the NICD in nucleus. |
| | Followed by the hyper-phosphorylation, NICD |
| | undergoes FBW7 dependent ubiquitin degradation. |
| NICD_ACTIVE + CSL + !COR + COA = | NRARP is the notch target gene which is |
| NRARP | transcribed by the CSL dependent NOTCH |
| | pathway activation. |
| !NRARP + NICD1/2/3/4 = NUC_NICD1/2/3/4 | NRARP is found to form a ternary complex with |
| | NICD in cytoplasm which in turn inhibits the |
| | further NICD dependent transcription. This is one |
| | of the identified negative feedback loop in NOTCH |
| | signaling pathway. |
| NUC_NICD1 = CDK2 | NUC_NICD1 induces the activation of CDK2. |
| HES1/5 + JAK2 + STAT3 = STAT3_P | HES1 and HES5 are found to interact with JAK2 |
| STAT3_P = NUC_STAT3 | and STAT3, and facilitate the complex formation |
| | between JAK2/STA3. This complex formation |
| | promotes the phosphorylation of STAT3. |
| | Phosphorylated STAT3_P then translocate into the |
| | nucleus. |
| NUC_STAT3 = HIF1A | NUC_STAT3 is found to activate HIF1A. |
| HIF1A = NICD1/2/3/4 | HIF1A can interact with NICD1/2/3/4 to enhance |
| | the NOTCH pathway activity by up regulating the |
| | NOTCH pathway target genes. |
| !HES1 = PTEN | NOTCH pathway is found to activate the |
| !PTEN = PI3K | PTEN/AKT pathway by upregulating HES1 |
| PI3K = AKT | production. HES1 is found to inhibit the PTEN |
| | dependent suppression of AKT activation. |

OUTPUT MOLECULES

| | |
|---|---|
| NECD1 | Output molecules of the model. |
| NECD2 | |
| NECD3 | |
| NECD4 | |
| AKT | |
| CDK2 | |
| HEY1 | |
| HEY2 | |
| MAG | |
| NFKB | |
| MYOD | |
| GATA3 | |
| CD44 | |
| P21 | |
| KLF5 | |
| PTCRA | |
| MYC | |
| HES7 | |
| HEYL | |
| MKP_1 | |
| CCND3 | |
| CCND1 | |
| FLIP | |
| IAP | |
| BCL2 | |
| SOX9 | |
| P65 | |
| P50 | |
| C_REL | |
| REL_B | |

Here ‘+’ sign in the logical equations signifies the ‘AND’ operation instead of conventional ‘OR’ logical operator. In CellNetAnalyzer the input equations should contain ‘+’ sign to signify the AND relation among the nodes. Nodes related with OR operations are given by individual logical equations.

TABLE 5
Logical expressions of the input molecules used for
simulation of Notch pathway under different scenarios

| | EXPERI- | SIMULA- | GAMMA_SECRE- | Normal Notch | | |
|---|---|---|---|---|---|---|
| | MENT | TION | TASE INHIBITION | Scenario | | |
| PROTEIN | (GBE) | (GBS) | (GSI) | (NNS) | TS2 | TS1 |
| JAG1 | 1 | 1 | 1 | 1 | 1 | 1 |
| JAG2 | 0 | 0 | 0 | 1 | 0 | 0 |
| DLL1 | 0 | 0 | 0 | 1 | 0 | 0 |
| DLL3 | 0 | 0 | 0 | 1 | 0 | 0 |
| DLL4 | 2 | 1 | 2 | 1 | 1 | 1 |
| MAGP1 | 1 | 1 | 1 | 0 | 1 | 1 |
| MAGP2 | 2 | 0 | 2 | 0 | 0 | 0 |
| NOV | 2 | 1 | 2 | 0 | 1 | 1 |
| CNTN1 | 0 | 0 | 0 | 0 | 0 | 0 |
| TACE | 1 | 1 | 1 | 1 | 1 | 1 |
| PRESENILIN1 | 0* | 1* | 0 | 1 | 1 | 1 |
| NICASTRIN | 1 | 1 | 1 | 1 | 1 | 1 |
| APH1 | 1 | 1 | 1 | 1 | 1 | 1 |
| PEN2 | 1 | 1 | 1 | 1 | 1 | 1 |
| FURIN | 2 | 1 | 2 | 0 | 1 | 1 |
| NEDD4 | 1 | 1 | 1 | 0 | 1 | 1 |
| ITCH | 1 | 1 | 1 | 0 | 1 | 1 |
| NUMB | 2 | 0 | 2 | 0 | 0 | 0 |
| ALPHA_ADAPTIN | 2 | 0 | 2 | 1 | 0 | 0 |
| O_GLUCOSE | 2 | 1 | 2 | 1 | 1 | 1 |
| POGLUT_1 | 1 | 1 | 1 | 1 | 1 | 1 |
| XYL | 2 | 0 | 2 | 0 | 0 | 0 |
| XYLE | 0 | 0 | 0 | 1 | 0 | 0 |
| NGA | 2 | 1 | 2 | 1 | 1 | 1 |
| O_FUCOSE | 2 | 1 | 2 | 1 | 1 | 1 |
| FRINGE | 1 | 1 | 1 | 1 | 1 | 1 |
| GALACTOSE | 2 | 1 | 2 | 1 | 1 | 1 |
| GASE | 1 | 1 | 1 | 1 | 1 | 1 |
| POFUT_1 | 1 | 1 | 1 | 1 | 1 | 1 |
| JIP1 | 0 | 0 | 0 | 1 | 0 | 0 |
| RAS | 0 | 0 | 0 | 1 | 0 | 0 |
| DVL | 0 | 0 | 0 | 0 | 0 | 0 |
| JAK2 | 2 | 1 | 2 | 0 | 1 | 1 |
| STAT3 | 1 | 1 | 1 | 0 | 1 | 1 |
| GSK_3BETA | 0 | 0 | 0 | 0 | 0 | 0 |
| WDR12 | 1 | 1 | 1 | 1 | 1 | 1 |
| P53 | 1 | 1 | 1 | 1 | 1 | 1 |
| FBW7 | 0 | 0 | 0 | 0 | 0 | 0 |
| CDK8 | 0 | 0 | 0 | 0 | 0 | 0 |
| CYCC | 2 | 0 | 2 | 0 | 0 | 0 |
| DTX1 | 0 | 0 | 0 | 0 | 0 | 0 |
| MAML | 1 | 1 | 1 | 1 | 0 | 1 |
| EP300 | 2 | 1 | 2 | 1 | 1 | 1 |
| SKIP | 2 | 1 | 2 | 1 | 1 | 1 |
| HAT | 1 | 1 | 1 | 1 | 1 | 1 |
| SMAD3 | 2 | 1 | 2 | 1 | 1 | 1 |
| CSL | 2 | 1 | 2 | 1 | 1 | 1 |
| SMRT | 1 | 1 | 1 | 0 | 1 | 1 |
| SAP30 | 1 | 1 | 1 | 0 | 1 | 1 |
| HDAC | 2 | 0 | 2 | 0 | 0 | 0 |
| CIR | 0 | 0 | 0 | 0 | 0 | 0 |
| SIN3A | 2 | 0 | 2 | 0 | 0 | 0 |
| YY1 | 0 | 0 | 0 | 1 | 0 | 0 |

*At the time of Glioblastoma Simulation (GBS), logical expression of PRESENILIN1 was considered as ‘1’, though in order to make the logical state of GAMMA SECRETASE as ‘1’, we had to assume the logical of PRESENILIN1 state as ‘1’, though in the expression data, expression of PRESENILIN1 was found “Up regulated”. Hence, ‘1’ and ‘0’represent ON or Up Regulation; and OFF or Down Regulation respectively. ‘2’ represents that the data is not available in the experimental microarray dataset.

TABLE 6
The simulation result of the intermediate and output
proteins of Notch pathway under different scenarios

| | EXPERI- | SIMULA- | GAMMA_SECRE- | Normal Notch | | |
|---|---|---|---|---|---|---|
| | MENT | TION | TASE INHIBITION | Scenario | | |
| PROTEIN | (GBE) | (GBS) | (GSI) | (NNS) | TS2 | TS1 |
| NOTCH1 | 1 | 1 | 1 | 1 | 0 | 1 |
| NOTCH2 | 1 | 1 | 1 | 1 | 0 | 1 |
| NOTCH3 | 1 | 1 | 1 | 1 | 0 | 1 |
| NOTCH4 | 2 | 1 | 1 | 1 | 0 | 1 |
| NEXT1 | 2 | 1 | 1 | 1 | 0 | 1 |
| NEXT2 | 2 | 1 | 1 | 1 | 0 | 1 |
| NEXT3 | 2 | 1 | 1 | 1 | 0 | 1 |
| NEXT4 | 2 | 1 | 1 | 1 | 0 | 1 |
| GAMMA SECRETASE | 1 | 1 | 0 | 1 | 1 | 1 |
| NOTCH1_PRE | 2 | 1 | 1 | 1 | 0 | 1 |
| NOTCH2_PRE | 2 | 1 | 1 | 1 | 0 | 1 |
| NOTCH3_PRE | 2 | 1 | 1 | 1 | 0 | 1 |
| NOTCH4_PRE | 2 | 1 | 1 | 1 | 0 | 1 |
| PTEN | 0 | 0 | 0 | 0 | 0 | 1 |
| STAT3_P | 2 | 1 | 1 | 0 | 0 | 1 |
| PI3K | 2 | 1 | 1 | 1 | 0 | 1 |
| AKT | 1 | 1 | 1 | 1 | 0 | 1 |
| NICD1 | 2 | 1 | 1 | 1 | 0 | 0 |
| NICD2 | 2 | 1 | 1 | 1 | 0 | 0 |
| NICD3 | 2 | 1 | 1 | 1 | 0 | 0 |
| NICD4 | 2 | 1 | 1 | 1 | 0 | 0 |
| P53_P | 2 | 0 | 0 | 0 | 0 | 1 |
| NUC_NICD1 | 2 | 1 | 1 | 1 | 0 | 1 |
| NUC_NICD2 | 2 | 1 | 1 | 1 | 0 | 1 |
| NUC_NICD3 | 2 | 1 | 1 | 1 | 0 | 1 |
| NUC_NICD4 | 2 | 1 | 1 | 1 | 0 | 1 |
| NUC_STAT3 | 2 | 1 | 1 | 0 | 0 | 1 |
| CDK2 | 1 | 1 | 1 | 1 | 0 | 1 |
| COR | 2 | 0 | 0 | 0 | 0 | 0 |
| COA | 2 | 1 | 1 | 1 | 0 | 0 |
| NECD1 | 2 | 1 | 1 | 1 | 0 | 0 |
| NECD2 | 2 | 1 | 1 | 1 | 0 | 0 |
| NECD3 | 2 | 1 | 1 | 1 | 0 | 0 |
| NECD4 | 2 | 1 | 1 | 1 | 0 | 1 |
| HES1 | 2 | 1 | 1 | 1 | 0 | 1 |
| HES5 | 0 | 1 | 1 | 1 | 0 | 1 |
| HES7 | 1 | 1 | 1 | 1 | 0 | 1 |
| HEY1 | 2 | 1 | 1 | 1 | 0 | 1 |
| HEY2 | 0 | 1 | 1 | 1 | 0 | 1 |
| HEYL | 1 | 1 | 1 | 1 | 0 | 1 |
| MAG | 0 | 0 | 0 | 0 | 0 | 0 |
| NRARP | 2 | 1 | 1 | 1 | 0 | 1 |
| NFKB | 1 | 1 | 1 | 1 | 0 | 1 |
| MYOD | 0 | 0 | 0 | 0 | 1 | 0 |
| GATA3 | 1 | 1 | 1 | 1 | 0 | 1 |
| CD44 | 1 | 1 | 1 | 1 | 0 | 1 |
| P21 | 1 | 1 | 1 | 1 | 0 | 1 |
| KLF5 | 2 | 1 | 1 | 1 | 0 | 1 |
| PTCRA | 2 | 1 | 1 | 1 | 0 | 1 |
| MYC | 1 | 0 | 0 | 1 | 0 | 1 |
| HIF1A | 1 | 1 | 1 | 1 | 0 | 0 |
| MKP_1 | 1 | 1 | 1 | 1 | 0 | 1 |
| CCND3 | 2 | 1 | 1 | 1 | 0 | 1 |
| CCND1 | 2 | 1 | 1 | 1 | 0 | 1 |
| FLIP | 1 | 1 | 1 | 1 | 0 | 1 |
| IAP | 2 | 1 | 1 | 1 | 0 | 1 |
| BCL2 | 2 | 1 | 1 | 1 | 0 | 1 |
| SOX9 | 1 | 1 | 1 | 1 | 0 | 1 |
| P65 | 1 | 1 | 1 | 1 | 0 | 1 |
| P50 | 0 | 1 | 1 | 1 | 0 | 1 |
| C_REL | 2 | 1 | 1 | 1 | 0 | 1 |
| REL_B | 1 | 1 | 1 | 1 | 0 | 1 |
| NICD_ACTIVE | 2 | 1 | 1 | 1 | 0 | 1 |

Normal Notch Scenario (NNS); Glioblastoma Scenario (GBS); Gamma Secretase Inhibition (GSI), In-silico Treatment Scenario by inhibiting NICD1 and MAML (TS2); and the inhibition by NICD1 and HIF1A (TS1). The logical states of the input proteins for each scenario and the respective simulated results of the output proteins are given in Table S4 and S5 respectively. The logical state ‘1’ or ‘0” represent the ON or OFF state of a protein in the simulation respectively. ‘2’ represents that the data is not available in the experimental microarray dataset.

The authors have previously published related work under:

Chowdhury, S. and Sarkar R. R. 2013 “Drug targets and biomarker identification from computational study of human Notch signalling pathway” Clin Exp Pharmacol 3(137): 2161-1459.

It is understood that the examples and embodiments described herein are for illustrative purposes only and that various modifications or changes in light thereof will be suggested to persons skilled in the art and are to be included within the spirit and purview of this application and scope of any appended claims. All figures, tables, and appendices, as well as publications, patents, and patent applications, cited herein are hereby incorporated by reference in their entirety for all purposes.

What is claimed is:

1. An in-silico method to identify combinatorial oncoproteins as potential drug targets that inhibit Notch pathway activity in Glioblastoma required to control or treat glioma in a subject comprising;
i. Reconstructing novel NOTCH pathway by collating proteins from the various databases; and
ii. simulating the logical models of Normal Notch Pathway scenario (NNS), Glioblastoma Scenario (GBS), Gamma Secretase Inhibitor Scenario (GSI) as well as drug treated scenario in Cell Net Analyzer to identify the combination oncoproteins as potential drug targets involved in the abnormal activation of NOTCH pathway in the development of glioblastoma (FIG. 2).

2. The in-silico method according to claim 1, wherein the logical analysis of step (ii) comprises;
i. comparing computationally the number of upstream activator proteins of NOTCH1, NOTCH4, NICD1/2/3/4, HES1, HEY1, IAP, BCL2, FLIP, CCND1, CCND3 etc. selected from FIG. 3A; number of downstream proteins activated by the proteins NOTCH2, NOV, MAGP1, JAK2, STAT5, NUC_NICD1/2/3/4, CSL, YY1, WDR12 etc. selected from FIG. 3B; number of upstream inhibitor proteins of STAT3_P, PI3K, AKT, P53_P, CDK2, GATA3 etc. selected from FIG. 3C; and number of downstream proteins inhibited by the proteins Nuclear Co-repressor complex (COR), P53, CDK8, CYCC, HEY1 etc. selected from FIG. 3D of the glioblastoma scenario with each protein of the normal scenario;
ii. identifying the proteins with significant variations in cancer scenario with respect to the normal scenario; and
iii. selecting combinations of target proteins from step (ii) for glioblastoma scenario comprising NICD1 & HIF1A and NICD1 & MAML proteins and perturbing said combination of proteins in the treatment scenario to inhibit the expression of the output oncoproteins of the NOTCH pathway causing glioblastoma.

3. The in-silico method according to claim 2, wherein the number of upstream activator proteins in the glioma scenario is greater than that of the normal scenario thereby effecting the expression of the output oncoproteins.

4. The in-silico method according to claim 2, wherein each target protein is assigned ‘0’ or ‘OFF’ and ‘1’ or ‘ON’ to up regulate or down regulate the expression of said protein.

5. The in-silico method according to claim 2, wherein the output oncoproteins comprises HES1, HES5, HEY1, HEY2, MAG, NRARP, NFKB, HES7, HEYL, MKP_1, CCND3, CCND1, MYOD, GATA3, CD44, P21, KLF5, PTCRA, MYC, HIF1A, FLIP, IAP, BCL2, SOX9, P65, P50, C-REL, REL-B.

6. The in-silico method according to claim 2, wherein the down regulation of output oncoproteins alters the phenotypic outcomes or cellular responses such asTranscription, myelination, cell-division, myogenic differentiation, anti-apoptosis, keratinocyte growth, NFKB signalling and hypoxia.

7. The in-silico method according to claim 2, wherein the combinatorial oncoproteins as potential drug targets comprises the combination of NICD1 & HIF1A for partial suppression of the Notch activity and combination of NICD1 & MAML oncoproteins for complete suppression of Notch activity in the treatment of glioblastoma.

8. The in-silico method according to claim 1, wherein the databases is selected from KEGG, REACTOME, NETPATH, BIOCARTA, and WIKI PATHWAYS etc. (Table 1).

9. The in-silico method according to claim 1, wherein the Notch pathway comprises 115 molecules (96 core and 19 cross talking pathway molecules including proteins and organic compounds) and 231 molecular interactions.

10. An in-silico method for selecting cancer treatment regime for glioma or cancer comprising perturbation of logical states of combination proteins selected from NICD1 & HIF1A and combination of NICD1 & MAML from 1 (“ON”) to 0 (“OFF”) of the Notch pathway in the treatment scenario to down regulate the expression of NICD/CSL constituted transcription factor and subsequently suppressing the expression of output onco proteins such as HES1, HES5, HEY1, HEY2, MAG, NRARP, NFKB, HES7, HEYL, MKP_1, CCND3, CCND1, MYOD, GATA3, CD44, P21, KLF5, PTCRA, MYC, HIF1A, FLIP, IAP, BCL2, SOX9, P65, P50, C-REL, REL-B as well as the phenotypic expressions of the glioma tumour cell line.

11. Use of combinatorial oncoproteins comprising combination of NICD1 & HIF1A and combination of NICD1 & MAML as potential drug targets in the Notch pathway to control or treat glioma and cancer.

12. An in-silico method to identify combinatorial oncoproteins biomarkers as potential drug targets that inhibit Notch pathway activity in Glioblastoma required to control or treat glioma tumour in a subject comprising;
i. Reconstructing novel NOTCH pathway by collating proteins from the various databases;
ii. simulating the logical models of Normal Notch Pathway scenario (NNS), Glioblastoma Scenario (GBS), Gamma Secretase Inhibitor Scenario (GSI) as well as drug treated scenario in Cell Net Analyzer to identify the combination oncoproteins biomarkers involved in the abnormal activation of NOTCH pathway in the development of glioblastoma.

13. The in-silico method according to claim 12, wherein the logical analysis of step (ii) comprises;
i. comparing computationally the number of upstream activator proteins of NOTCH1, NOTCH4, NICD1/2/3/4, HES1, HEY1, IAP, BCL2, FLIP, CCND1, CCND3 etc. selected from FIG. 3A; number of downstream proteins activated by the proteins NOTCH2, NOV, MAGP1, JAK2, STAT3, NUC_NICD1/2/3/4, CSL, YY1, WDR12 etc. selected from FIG. 3B; number of upstream inhibitor proteins of STAT3_P, PI3K, AKT, P53_P, CDK2, GATA3 etc. selected from FIG. 3C; and number of downstream proteins inhibited by the proteins Nuclear Co-repressor complex (COR), P53, CDK8, CYCC, HEY1 etc. selected from FIG. 3D of the glioblastoma scenario with each protein of the normal scenario;
ii. identifying the oncoprotein biomarkers with significant variations in cancer scenario with respect to the normal scenario; and
iii. selecting combinations of oncoprotein biomarkers from step (ii) for glioblastoma scenario comprising NICD1 & HIF1A and NICD1 & MAML proteins and perturbing said combination of proteins in the treatment scenario to inhibit the expression of the output oncoproteins of the NOTCH pathway causing glioblastoma.

14. The in-silico method according to claim 13, wherein the number of upstream activator proteins in the glioma scenario is greater than that of the normal scenario thereby effecting the expression of the output oncoproteins.

15. The in-silico method according to claim 13, wherein each target protein is assigned ‘0’ or ‘OFF’ and ‘1’ or ‘ON’ to up regulate or down regulate the expression of said protein.

16. The in-silico method according to claim 13, wherein the output oncoproteins comprises HES1, HES5, HEY1, HEY2, MAG, NRARP, NFKB, HES7, HEYL, MKP_1, CCND3, CCND1, MYOD, GATA3, CD44, P21, KLF5, PTCRA, MYC, HIF1A, FLIP, IAP, BCL2, SOX9, P65, P50, C-REL, REL-B.

17. The in-silico method according to claim 13, wherein the down regulation of output oncoproteins alters the phenotypic outcomes or cellular responses such as Transcription, myelination, cell-division, myogenic differentiation, anti-apoptosis, keratinocyte growth, NFKB signalling and hypoxia.

18. The in-silico method according to claim 13, wherein the combinatorial oncoproteins as biomarkers comprises the combination of NICD1 & HIF1A for partial suppression of the Notch activity and combination of NICD1 & MAML oncoproteins for complete suppression of Notch activity in the treatment of glioblastoma.

19. The in-silico method according to claim 12, wherein the Notch pathway comprises 115 molecules (96 core and 19 cross talking pathway molecules including proteins and organic compounds) and 231 molecular interactions.

20. Use of combinatorial oncoprotein biomarkers comprising combination of NICD1 & HIF1A and combination of NICD1 & MAML as potential drug targets in the Notch pathway to control or treat glioma.
